(19) United States
(12) Patent Application Publication
(10) Pub. No.: US 2026/0124993 A1
(43) Pub. Date: May 7, 2026

(54) Modular assembly for being arranged on a motor vehicle, comprising an adjustment element

(71) Applicant: Brose Fahrzeugteile SE & Co. Kommanditgesellschaft, Bamberg, Bamberg (DE)

(72) Inventors: Harald HUGEL, Bamberg (DE); Christian GITTER, Zeil am Main (DE); Samip KATWATE, Karad (IN); Simon SCHMUCK, Coburg (DE); Vitthal SHIPPARKAR, Nanded (IN)

(21) Appl. No.: 19/380,501

(22) Filed: Nov. 5, 2025

(30) Foreign Application Priority Data
Nov. 5, 2024 (DE) 102024132220.9

(51) Int. Cl. B60R 5/02; B60R 13/01

(52) U.S. Cl. CPC B60R 5/02; B60R 13/013

(57) ABSTRACT

The proposed solution relates to a modular assembly for being arranged on a motor vehicle, comprising a cargo space for storing objects in the motor vehicle, an access opening to the cargo space via which an object can be introduced into the cargo space for storage on a cargo space floor, and an adjustment element with which the access opening can be closed and which is provided in addition to a hood element for closing a loading opening of the cargo space and/or is arranged on a front section of the motor vehicle when the assembly is arranged as intended on the motor vehicle.

### CROSS-REFERENCE TO RELATED APPLICATION

This application claims priority pursuant to 35 U.S.C. 119(a) to German Patent Application No. 102024132220.9, filed Nov. 5, 2024, which application is incorporated herein by reference in its entirety.

### FIELD OF THE INVENTION

The proposed solution relates to a modular assembly for a motor vehicle and a motor vehicle.

### BACKGROUND

While conventional motor vehicles usually have a cargo space in the vehicle's rear region in which cargo can be stowed, modern vehicle concepts, in particular electrically powered motor vehicles (so-called electric vehicles), can also have free installation space in the front region of the vehicle (because no installation space is taken up by an internal combustion engine there), so that additional cargo space is available in the front of the vehicle. A cargo space located in the front of a vehicle is also called a “frunk” (a combination of the terms “front”and “trunk”).

The cargo space can be provided by the modular assembly, which can be arranged in the installation space. Similar to a hood in conventional motor vehicles, a hood element is often also present in modern vehicle concepts. This can be used to close the cargo space. When the hood element is open, the cargo space can then be loaded via a loading opening arranged above the cargo space. An object that is to be brought into the cargo space by a user usually has to be lifted over a loading sill. In this case, a distance may have to be covered that corresponds to the width of one wheel of the motor vehicle or more. Depending on the design of the cargo space, the user may still need to stoop to place the object safely on the cargo floor. Loading therefore requires the user to assume an ergonomically unfavorable posture.

It is generally desirable to make a loading possible that is less ergonomically stressful. From DE 20 2019 106 016 U1, for example, a front trunk is known to be loaded via a front opening which can be closed off by a radiator grille of the motor vehicle. The user does not have to lift an object over a loading sill to load said object. Depending on the height of the vehicle with which the modular assembly is arranged, the user may not even need to stoop.

### SUMMARY

Against this background, the proposed solution is based on the object of providing a modular assembly for being arranged on a motor vehicle which has a cargo space for storing objects in the motor vehicle, an access opening to the cargo space via which an object can be introduced into the cargo space for storage on a cargo space floor, and an adjustment element by means of which the access opening can be closed and which offers an improved user experience.

This object is achieved by the features described herein, according to which a modular assembly for being arranged on a motor vehicle comprising a cargo space for storing objects in the motor vehicle, an access opening to the cargo space via which an object can be introduced into the cargo space for storage on a cargo space floor, and an adjustment element is provided by means of which the access opening can be closed and which is provided in addition to a hood element for closing a loading opening of the cargo space and/or is arranged in a front section of the motor vehicle when the assembly is arranged as intended on the motor vehicle.

According to a first variant, the adjustment element has a first section and a second section, wherein the first section is adjustable along a first adjustment path and the second section along a second adjustment path, in each case at least in sections, in a plane parallel or oblique to the cargo space floor in order to open the access opening, or wherein a dividing plane which divides the adjustment element into the first and second sections is arranged perpendicular to the loading floor.

According to a second variant, the adjustment element is arranged on the cargo space via at least one first and at least one second adjustment arm, wherein the adjustment element is adjustable between a closed position, in which the access opening is closed, and an open position, in which the access opening is open, by a rotary adjustment movement of the at least one first adjustment arm and a translational adjustment movement of the at least one second adjustment arm.

According to a third variant, the adjustment element is mounted so as to be pivotable about an axis of rotation relative to the cargo space, wherein the mounting is eccentric in relation to the axis of rotation and/or wherein at least one adjustment arm is provided on the adjustment element, which arm can be actuated via a linear drive in order to pivot the adjustment element.

According to a fourth variant, the adjustment element is adjustable via an adjustment device having at least two adjustment arms which are coupled to one another.

According to a fifth variant, the adjustment element is adjustable via an adjustment device having at least one sliding guide.

According to a sixth variant, the adjustment element is pivotally mounted relative to the cargo space about an axis of rotation which divides the adjustment element into a first and a second section.

The loading opening may be an opening for loading the cargo space which is arranged along the earth's gravity line above the cargo space when the modular assembly is used as intended. The access opening may be an opening for loading the cargo space which, along the earth's gravity line, is at the same height as the cargo space when the modular assembly is used as intended. The access opening can be sealed by a sealing element against which the adjustment element rests in a closed position. The access opening can be framed by at least a section of the cargo space wall and/or a separate frame element. Correspondingly, the sealing element can seal the cargo space at the cargo space wall and/or at the frame element. The loading opening can be larger (in terms of area) than the access opening. The access opening can be used, for example, for quickly depositing smaller objects. The hood element can be larger than the adjustment element, so that adjusting the hood element may not seem appropriate for a user if he only wants to store small objects in the cargo space.

The cargo space may have a cargo space wall that projects upward from the cargo space floor.

The cargo space can basically be divided into a first and a second section. The second section may be adjacent to the access opening. In particular, the second section may have a smaller volume than the first section. For example, the second section may be narrower (transversely to the direction of travel) than the first section. This means that the second section of the cargo space can, for example, fill an installation space between two headlights of a motor vehicle.

It is conceivable and possible for the first and second sections to be separated from one another (for example by a separating element). In such a case, the first section of the cargo space can be completely enclosed by a first section of the cargo space wall. When the hood element is closed, the first section of the cargo space can then be completely enclosed by a first section of the cargo space floor, by the first section of the cargo space wall and by the hood element.

Furthermore, the second section of the cargo space (regardless of whether the first and second sections are separate from one another) can be partially enclosed by a second section of the cargo space wall. The second section of the cargo space wall may project upward from the second section of the cargo space floor. For example, the second section of the cargo space wall may consist of two sub-sections that project upward from opposite sides of the cargo space floor. In principle, the access opening can be a (closable) opening in the cargo space wall, in particular an opening extending between the two sub-sections.

The adjustment element can, for example, comprise a radiator grille of the motor vehicle. The adjustment element allows air to be exchanged with the environment of the modular assembly. For example, air from the environment can be supplied to the interior of the motor vehicle via the adjustment element. The adjustment element may additionally or alternatively comprise a carrier element. The carrier element can make it possible to design the adjustment element in any way desired. For example, a trim element and/or a decorative element such as the logo of a manufacturer of the motor vehicle can be arranged on the carrier element. In principle, the adjustment element can have an outward design that is identical to the design of a body of the motor vehicle (for example, a painted and/or smooth surface). Alternatively, the adjustment element may have a textured surface on a side facing away from the cargo space. Due to the textured surface, the adjustment element can differ from the body of the vehicle. The textured surface may, for example, have a pattern of depressions and elevations, a periodic structure and/or a plurality of depressions having a depth of more than 0.1 cm.

The trim element may have a recess in which the carrier element is arranged. In addition, at least part of an adjustment device for the adjustment element and/or a floor element for extending the cargo space floor can be arranged in the recess. In a closed position of the adjustment element, in which the adjustment element closes the access opening, elements arranged in the recess can be hidden from the outside.

In the closed position relative to the cargo space, the adjustment element can be secured against improper adjustment by means of a locking device. The locking device may comprise a locking device having at least one (conical) pin which, in the closed position, engages in an associated (conical) pin receptacle. The at least one conical pin can be locked in the closed position by an associated locking element in the pin receptacle. In particular, two pins may be provided.

For adjusting the adjustment element, an adjustment device can be provided which has a linear drive (e.g. with a spindle) or any other adjustment drive such as a rotary adjustment drive or a flexible traction means and a traction means drive. The respective drives can have an electric motor.

The adjustment element can be adjustable (foldable) between the open and the closed position, for example by pivoting through an angle between 80° and 100°, in particular 90°. Alternatively, the adjustment element can be adjusted by parallel movement without rotation between the open and closed positions. It is also conceivable and possible for the adjustment element to perform a combined translation and rotation for the adjustment.

According to the first variant, the adjustment element has a first section and a second section, wherein the first section is adjustable along a first adjustment path and the second section along a second adjustment path, in each case at least in sections, in a plane parallel or oblique to the cargo space floor in order to open or close the access opening, or wherein a dividing plane which divides the adjustment element into the first and second sections is arranged perpendicular to the loading floor. In particular, the first adjustment path can be mirror-symmetrical to the second adjustment path. The mirror symmetry can, for example, be relative to a plane of symmetry with respect to the cargo space floor. The plane of symmetry can be oriented along the direction of travel of the motor vehicle. The first and second adjustment paths can extend transversely to the direction of travel. In particular, a tangent can be extended transversely to the direction of travel at least one point on the first and/or the second adjustment paths. More than 50% of the length of the relevant adjustment path can be extended transversely to the direction of travel.

The first and second adjustment paths can be curved. Alternatively, the first and second adjustment paths can be L-shaped. In principle, it is conceivable and possible for the first and second adjustment paths to be designed differently from one another (i.e. not necessarily mirror-symmetrically).

The first and second sections of the adjustment element can, in a closed position in which they close the access opening, form a closed, outward-facing (away from the cargo space) surface of the adjustment element. The surface can form the front side of the motor vehicle. In particular, the adjustment element can be divided into the first and the second sections, in particular mirror-symmetrically, by the dividing plane. The dividing plane can be arranged such that it extends along the direction of travel when the modular assembly is used as intended in a motor vehicle. A dividing axis (possibly in the dividing plane), along which the adjustment element is divided into the first and second sections, can be arranged perpendicularly or obliquely to the loading floor. Such a vertical division of the adjustment element can create a possibility for opening the access opening, which is characterized by an adjustment device of low complexity and by space-saving adjustment paths.

In one embodiment, an adjustment device comprising at least two adjustment arms is provided, wherein the first section of the adjustment element is arranged on at least one first adjustment arm and the second section of the adjustment element is arranged on at least one second adjustment arm. The at least two adjustment arms can each extend through a recess in the cargo space wall. The at least two adjustment arms can be arranged on the cargo space in such a way that the associated mounting points are each arranged in front of the recess in the direction of travel. For example, the at least two adjustment arms can be curved (for example by a bevel and/or an arcuate section). A curved shape can also be provided independently of this arrangement.

In one embodiment, the at least two adjustment arms are rotatably mounted relative to the cargo space and/or the respective section of the adjustment element is rotatably mounted on the respective adjustment arm. The at least two adjustment arms can, for example, each have a mounting point on the side of the adjustment element and/or a mounting point on the side of the cargo space. The respective section of the adjustment element can be mounted at the mounting point assigned to it, so that it can rotate relative to the respective adjustment arm. In addition, the at least two adjustment arms can be rotatable relative to a mounting base on the side of the cargo space. Due to the rotatable mounting of the sections of the adjustment element on the adjustment arms, an orientation of the sections of the adjustment element toward a pivoting plane, in which the relevant section of the adjustment element is pivoted by pivoting the at least two adjustment arms about the respective mounting base, can be kept constant during the adjustment movement, whereby less space is required for the adjustment. The pivoting plane can be parallel or oblique (for example at an angle of less than 10°, in particular less than 5°) to the cargo space floor. In a closed position in which the access opening is closed the two sections of the adjustment element can be parallel to their orientation in an open position in which the access opening is open.

A linear drive or a rotary adjustment drive can be provided for adjusting the sections of the adjustment element. The linear drive can, for example, have a spindle drive with a spindle, that is oriented in particular transversely to the direction of travel of the motor vehicle, on which the modular assembly can be arranged as intended. For example, the spindle can be located below the cargo space. For the adjustment, the linear drive can act directly on the relevant section of the adjustment element. In order to be able to follow a curved adjustment path, the linear drive can be pivoted relative to the cargo space and kinematically connected thereto.

According to the second variant, the adjustment element is arranged on the cargo space via at least one first and at least one second adjustment arm, wherein the adjustment element is adjustable between a closed position in which the access opening is closed and an open position in which the access opening is open by a rotational adjustment movement of the at least one first adjustment arm and by a translational adjustment movement of the at least one second adjustment arm. The adjustment of the adjustment element can therefore represent a combined pivoting and shifting. For example, in this way the adjustment element can be accommodated under the cargo space floor.

In one embodiment, the at least one first adjustment arm is pivotable about an axis of rotation which is arranged transversely to a translation axis along which the at least one second adjustment arm is adjustable. The axis of rotation and/or the translation axis can be arranged parallel to the cargo space floor. The at least one first adjustment arm can be rotatably connected to the adjustment element via a first mounting point. Via a second mounting point, the at least one first adjustment arm can be arranged on a mounting base fixed to the cargo space (e.g. a hole for receiving a fastening means) so as to be pivotable about the axis of rotation. The axis of rotation through the first mounting point may be parallel to the axis of rotation through the second mounting point. The mounting base may, for example, be arranged on an outer side of the cargo space wall (which faces away from the cargo space). The at least one second adjustment arm can be adjustable along the translation axis, for example, via a guide assembly (which, for example, has a guide rail). For this purpose, the at least one second adjustment arm can have a first section, to which the at least one second adjustment arm is rotatably connected to the adjustment element via a first mounting point, and a second section via which the at least one second adjustment arm is guided on the guide assembly. During the adjustment movement of the adjustment element, the adjustment element can thus be pivoted about the first mounting point of the at least one second adjustment arm.

In one embodiment, the first and second adjustment arms are arranged on different sides of the cargo space floor. The at least one first adjustment arm can, for example, be arranged on the side of the cargo space opposite the cargo space floor and the at least one second adjustment arm can be arranged on the side of the cargo space floor facing away from the cargo space. The translation axis can extend transversely to the access opening and/or along the direction of travel.

It is conceivable and possible for the adjustment of the adjustment element to be carried out via a rotary drive on the at least one first adjustment arm. Alternatively, or additionally, a translational drive can be provided on the at least one second adjustment arm. For example, this could be a drive via a flexible traction means or a drive via a spindle.

According to the third variant, the adjustment element is mounted so that it can pivot about an axis of rotation relative to the cargo space, whereby the mounting is eccentric to the axis of rotation. The axis of rotation can be arranged so that it extends parallel to the cargo space floor. For example, the axis of rotation can be arranged transversely to the direction of travel of the motor vehicle. The eccentric mounting of the adjustment element can mean that the adjustment element is mounted at a distance from the axis of rotation. In particular, the adjustment element cannot have an intersection point with the axis of rotation. With such a mounting, the adjustment element can move on a circular path about the axis of rotation during the pivoting movement. This means that the adjustment element as a whole can, for example, be positioned further away from the access opening compared to a mounting directly on the axis of rotation. In addition, such mounting may allow easier concealment of other elements, such as the adjustment device or a part thereof with which the adjustment element is adjustable.

In one embodiment, the adjustment element has a floor element with which the access opening is closed in a closed position of the adjustment element, and which is provided for extending the cargo space floor in an open position in which the access opening is open. In the closed position of the adjustment element, the floor element can, for example, abut the access opening. At the access opening, a sealing element can be extended along an outer contour of the access opening, which sealing element is arranged in the closed position between the floor element and the outer contour in order to seal the cargo space.

In principle, the floor element can be arranged on the same level as the cargo space floor in the open position, so that the user for storing objects has a continuous level (gapless but possibly with a step). It is conceivable and possible for the floor element to be arranged offset relative to the cargo space floor along an axis transverse to the cargo space floor, so that a step is arranged between the floor element and the cargo space floor.

In one embodiment, a pivot element is provided which is pivotally mounted on the axis of rotation and on which the adjustment element is arranged on a connecting section of the pivot element which is at a distance from the axis of rotation. The pivot element allows the adjustment element to be mounted eccentrically with respect to the axis of rotation. In principle, one or more pivot elements can be provided to provide an eccentric mounting for the adjustment element. Multiple pivot elements can improve mounting stability. By pivoting the pivot element, the adjustment element can be adjusted between the closed position and the open position. For this purpose, the pivot element can, for example, perform a pivoting movement in a range up to 120°, in particular 90°. A partial opening of the access opening (less than 80°pivoting movement) is basically conceivable and possible, for example in order to quickly remove objects from the cargo space. In an embodiment of the access opening transversely to the direction of travel, the pivoting movement can be carried out by 90°, for example, whereby the floor element can be brought into a position that is parallel to the cargo space floor. Alternatively, the access opening may be inclined relative to the direction of travel so that other adjustment angles can be provided by which the pivot element is pivoted to adjust the adjustment element from the closed to the open position.

The connecting section can, for example, have one or more fastening points such as screwing points via which the adjustment element can be fastened to the pivot element.

In one embodiment, the connecting section is connected via a curved connecting arm to a mounting section of the pivot element, on which the pivot element is mounted on the axis of rotation. The connecting section can form a T-shaped structure with the connecting arm. The curvature of the connecting arm can be formed in a plane transverse to the cargo space floor. The connecting arm can be arranged with a convex side toward the cargo space. Such an orientation makes it possible to at least partially hide the pivot element behind a trim component when the adjustment element is in the closed position. In the open position, the trim component can project into a concave side of the connecting arm. The connecting section and the mounting section can be arranged at opposite ends of the connecting arm.

In one embodiment, the adjustment element has a trim element with an end section which is arranged along an axis perpendicular to the axis of rotation between the connecting section and the axis of rotation. In principle, the end section of the trim element can be arranged above the connecting section, starting from the axis of rotation. The arrangement between the connecting section and the axis of rotation can make it easier to conceal the pivot element in the closed position of the adjustment element.

In one embodiment, a terminating element is provided which is made of the same material as the trim element and which has a head section which, in the closed position of the adjustment element, abuts the end section of the trim element. The terminating element can make it possible to conceal the mounting section of the pivot element from the outside. In particular, in the closed position of the adjustment element, the pivot element is concealed from the outside by the adjustment element and the terminating element. In the closed position, the trim element and the terminating element can contribute to an outwardly visible structure of the modular assembly. If they are made of the same material and the trim element abuts the terminating element, these two elements together can appear as a single piece. For example, the trim element and the terminating element can each be designed like sections of a radiator grille or of a one-piece decorative element. The length ratio between the terminating element and the trim element can be between 20:80 and 40:60, in particular 30:70, across the cargo space floor. The terminating element can therefore be shorter in height than the trim element. The width of the trim element and the terminating element transversely to the direction of travel can be identical.

The head section of the trim element may have a contour that corresponds to a contour of the end section of the trim element. In particular, the two contours can be identical. The contours can be formed in a sectional plane parallel to the cargo space floor.

The trim element and the terminating element can, for example, each have a surface facing away from the cargo space (in the direction of travel). The surfaces can merge seamlessly into one another and/or be designed to match and/or be arranged in one plane and/or have the same color. Such a surface design can enhance the uniform appearance of the terminating element and the trim component.

In one embodiment, the axis of rotation is arranged along a direction perpendicular to the cargo space floor at the same height as the terminating element. The terminating element can serve to conceal the axis of rotation (in particular the mounting section of the pivot element). The trim component can be displaced beyond the terminating element (in the direction of travel) by the pivot element by arranging the axis of rotation in this way, as seen from the cargo space. No adjustment device is required on the surface between the terminating element and the trim component, thus allowing more flexibility in the design of the surface.

In the pivoting of the adjustment element from the closed to the open position, the connecting arm of the pivot element can be adjusted such that the head section of the terminating element is arranged within the curvature of the connecting arm. An abutment or support at the end element is not necessary here.

In one embodiment, the pivot element has a support arm via which the floor element can be supported at least in the open position of the adjustment element. For example, the support arm can project from the connecting arm. In particular, the support arm can project from the convex side of the connecting arm. For example, the support arm can project from the connecting arm in a plane perpendicular to the axis of rotation. The support arm can be T-shaped. The support arm may have a flat support surface which may be arranged tangentially to an (imaginary) cylinder around the axis of rotation. This can provide optimal support for the floor element.

In principle, the floor element can be fixedly connected to the support arm. Alternatively, the floor element can loosely abut the support arm in the open position of the adjustment element so that it can be at a distance from it in the closed position. The floor element or a part thereof may be movable relative to the support arm if no fixed connection to the support arm is provided.

The curvature of the connecting arm may have a curvature tip arranged between the mounting section and the connecting section (e.g. in the middle therebetween). The support arm may extend from a section of the connecting arm located between the curvature tip and the mounting section. Such an arrangement allows a load that can be introduced into the support arm via the floor element to be better transferred to a mounting of the pivot element.

The support arm can be angled. The angular design provides a predetermined breaking point that, in the event of overload, gives way before the mounting section of the pivot element, via which the pivot element is mounted on the motor vehicle, is damaged.

In one embodiment, the floor element in the closed position is longer than the access opening along a direction perpendicular to the cargo space floor. For example, the floor element can be more than 10% longer than the access opening. In particular, the floor element can be more than 50% longer than the access opening. The length of the floor element extending beyond a height of the access opening can be provided below the cargo space floor in the closed position. Due to such a long floor element, the cargo space floor can be extended by the floor element when the adjustment element is open to allow objects to be stored. It can therefore be considerably more convenient to store objects in the cargo space. For example, a user can place an object on the floor element and push it into the cargo space.

In one embodiment, the floor element can be stowed below the cargo space floor in the closed position of the adjustment element, parallel or at an angle to the cargo space floor. In particular, more than 90% of the length of the floor element (in the direction of travel) can be stowed below the cargo space floor. If stowed at an angle to the cargo space floor, the floor element can form an acute angle with the cargo space floor.

In one embodiment, the floor element docks directly to the cargo space in the open position for extending the cargo space floor and/or docks to the cargo space via a bridging assembly. Docking can make a gapless abutment possible. In this design, the pivot element can be used to adjust the adjustment element. In principle, however, the adjustment of such a configuration can be carried out in any way and can in particular be combined with other exemplary embodiments in this disclosure.

In the open position of the adjustment element an extension of the cargo space floor by the floor element can be provided, for example, by the floor element abutting with one end the access opening. In particular, this end of the floor element can be at a distance from the access opening in the closed position and can about the access opening in the open position. The end of the floor element can thus be brought into a position on the cargo space floor by the adjustment movement of the adjustment element. This allows the installation space occupied by the floor element in the closed position to be optimized.

The floor element may have a step at the end where it abuts the access opening, the height of which step, transverse to the cargo space floor (in the open position), may correspond to at least one thickness of the cargo space floor. This means that the lower shoulder of the step in the open position can be arranged below the cargo space floor and an upper shoulder of the step can serve to extend the cargo space floor. In addition, the sealing element for sealing the access opening can be located between the lower shoulder and the upper shoulder on a section of the step that extends transversely to the cargo space floor, so that a gap at the transition from the cargo space floor to the floor element is sealed. In this way, a gapless loading surface can be provided.

When the floor element is docked to the cargo space via the bridging assembly, the floor element, the bridging assembly and the cargo space floor can provide a common loading surface in the open position of the adjustment element. The loading surface can basically be extended in one plane. Alternatively, a step may be provided at least between the bridging assembly and the cargo space floor. The bridging assembly can be designed such that in the closed position of the adjustment element it requires less installation space and/or a differently shaped volume than in the open position of the adjustment element. The adjustment of the adjustment element can be coupled with an adjustment of the bridging assembly, so that said bridging assembly is also adjusted by the adjustment of the adjustment element.

In one embodiment, the bridging assembly comprises a bridging element and an entrainment device via which the bridging element can be entrained by the adjustment element when the adjustment element is being adjusted. The bridging element may be provided for arrangement between the floor element and the cargo space floor in the open position. In the closed position, the bridging element can be arranged parallel to or at an angle of less than 20°, in particular less than 10°, to the floor element. In the open position of the adjustment element, the loading surface can consist of at least the floor element, the bridging element and the cargo space floor. The entrainment device can be provided to couple the adjustment of the adjustment element to the adjustment of the floor element. In principle, an adjustment of the bridging device can cause the adjustment of the adjustment element or, conversely, the adjustment of the adjustment element can cause the adjustment of the bridging device.

In one embodiment, the entrainment device has at least one entrainment lug arranged on either the adjustment element or the bridging element, and an associated guide element arranged on the other adjustment element or bridging element and on which the entrainment lug is guided.

The at least one entrainment lug can, for example, have a pin that projects from the adjustment element or from the bridging element parallel to the axis of rotation. In order to guide the at least one entrainment lug on the guide element assigned thereto, the at least one entrainment lug can engage in the guide element. A rail, for example, is suitable as a guide element.

With the entrainment device, it is conceivable and possible for the bridging element to be easily adjustable from a stowed position, in which it is stowed beneath the cargo space floor when the adjustment element is in the closed position, to a functional position, in which it docks to the cargo space floor and to the floor element (on opposite sides) when the adjustment element is in the open position.

The adjustment movement of the bridging element can be carried out translationally along a direction parallel to the cargo space floor in the first section of the adjustment movement and translationally perpendicular to the cargo space floor in a second section of the adjustment movement. A guide element suitable for realizing such an adjustment movement can be L-shaped. The guide element can be coupled to the adjustment element in such a way that the guide element is pivoted together with the adjustment element about the axis of rotation during adjustment from the closed to the open position. The entrainment lug can be correspondingly coupled to the bridging element. The coupling of the entrainment lug to the bridging element can be effected via a bracket that projects from the bridging element along the axis of rotation. Such a bracket can allow more flexibility in the arrangement of the guide element on the adjustment element.

In one embodiment, the entrainment device has a rigid coupling element which couples the first entrainment lug of the entrainment device to the adjustment element and a second entrainment lug of the entrainment device to the bridging element. Such a coupling element can be provided in addition to or alternatively to at least one entrainment lug and the associated guide element. The first and second entrainment lugs may project from one side of the bridging element and of the floor element along the axis of rotation. In principle, the entrainment device can have a first and a second such entrainment lug on the two opposite sides of the bridging element and of the floor element along the axis of rotation, the lugs being coupled via a coupling element.

In the closed position of the adjustment element, the bridging element can be stowed in a stowage position below the cargo space floor. The bridging element can form an obtuse angle with the cargo space floor. In particular, the bridging element can be stowed perpendicular to the cargo space floor. In the closed position, the bridging element can be stowed parallel to or at least at a slight angle to the floor element. The first and second entrainment lugs can be arranged on the floor element and on the bridging element in such a way that, during adjustment from the closed position to the open position, the floor element can be pivoted over the bridging element with one end that abuts the bridging element in the open position. Such an adjustment can be achieved in that a distance of the first entrainment lug from an end of the floor element, via which the floor element abuts the bridging element when the adjustment element is in the open position, is smaller than a distance of the second entrainment lug from an end of the bridging element, via which the bridging element abuts the floor element when the adjustment element is in the open position.

The bridging element can be pivotally mounted relative to the cargo space via at least one bridge base. The bridge base can, for example, be located below the cargo space floor. Via the coupling element, the adjustment element can thus entrain the bridging element during adjustment from the closed to the open position. Conversely, during the adjustment from the open to the closed position the adjustment element can via the rigid coupling element move the bridging element into a stowed position below the cargo space.

According to a modification of the third variant, according to which the adjustment element is pivotally mounted relative to the cargo space about an axis of rotation wherein the mounting is eccentric in relation to the axis of rotation, a floor element is provided in addition to the adjustment element. In this modification, the adjustment element can basically be pivoted by the pivot element as described above. The pivot element may have the features and advantages described above. In this modification, the adjustment element can also have a trim element, which can be arranged, for example, on a carrier element of the adjustment element. The pivot element can be arranged on the carrier element and/or on the trim element (if necessary, via a connecting section) as described above.

The floor element can be arranged in a stowed position under the cargo space floor in a closed position of the adjustment element in which the access opening is closed and can be provided for extending the cargo space floor in an open position in which the access opening is open.

With this modification, a space can be provided for the floor element under the cargo space floor. This can reduce the depth of a required installation space transverse to the cargo space floor (along an axis transverse to the direction of travel). When the modular assembly is used as intended in a motor vehicle, such a design of the floor element can allow a more flexible design of an air intake system that can be arranged under the modular assembly.

In one embodiment, the floor element is coupled to the adjustment element via an entrainment device so that it is entrained during adjustment between the closed and the open position. The entrainment device can be designed in such a way that, conversely, the adjustment element is also entrained during the adjustment of the floor element. By means of such a configuration, an adjustment device on the adjustment element or an adjustment device on the floor element can be used to adjust the other element as well, whereby the installation space in the vicinity of the modular assembly can be designed more flexibly in its intended use in a motor vehicle. An adjustment drive can be provided on the floor element and/or on the adjustment element.

In one embodiment, the entrainment device has at least one entrainment lug which is arranged on the floor element and interacts with an associated guide element in such a way that the floor element is adjusted translationally when the adjustment element is pivoted. The at least one entrainment lug can be pin-shaped and/or project parallel to the axis of rotation and the floor element. The associated guide element can, for example, comprise a slotted guide for at least one entrainment lug and/or be straight. In the open position, the guide element can form an angle of less than 10° with a loading surface of the floor element. In the closed position, the guide element can form an angle between 80° and 100°, in particular 90°, with the loading surface of the floor element.

According to the fourth variant (first alternative), the adjustment element is adjustable via an adjustment device having at least two adjustment arms that are coupled to one another. One of the at least two adjustment arms can be coupled to the adjustment element. In particular, the at least two adjustment arms can engage at a mounting point on the adjustment element. At the mounting point, the at least two adjustment arms can be pivotally connected relative to the adjustment element.

In one embodiment, the adjustment device has a first adjustment arm, via which the adjustment element is kinematically coupled to the cargo space, and a second adjustment arm, which is pivotally coupled to the first adjustment arm and which is positively guided along a straight line, so that an adjustment of the second adjustment arm causes a translation of the adjustment element. In particular, the at least two adjustment arms can be rigid.

The second adjustment arm can be guided at one end. The other end, which is hinged to the adjustment element, is forced by the guide to a translation (transverse to the guide movement at the one end), which the adjustment element also follows. The first adjustment arm limits the play for the adjustment element. Due to the forced guidance of the adjustment element on the first adjustment arm, the translation can be converted into a pivoting of the adjustment element about a mounting point of the first adjustment arm relative to the cargo space.

The straight line along which the second adjustment arm is positively guided can be arranged within an angle of 80° to 100°, in particular perpendicular, relative to the cargo space floor. The guide movement of the second adjustment arm can be effected via a drive force applied by a linear drive.

In one embodiment, a floor element is provided which is coupled to the adjustment element via an entrainment device so that it is entrained during adjustment between the closed and the open position. The floor element is mounted on the cargo space via a mounting. The mounting can, for example, include a guide rail. In particular, the floor element can be stowed under the cargo space floor. In the closed position of the adjustment element, the floor element is arranged in a stowed position under the cargo space floor. In the open position, the floor element serves to extend the cargo space floor. A step can be provided between the cargo space floor and the floor element. The mounting on the cargo space can be designed in such a way that the floor element can only be adjusted translationally.

Due to the double coupling of the adjustment element with the cargo space via the adjustment device and the entrainment device, adjustment with the adjustment device causes an additional rotation of the adjustment element about the mounting point on the at least two adjustment arms. In this way, an effective way is created for adjusting the adjustment element between the open and closed positions by a combined rotation and translation.

In one embodiment, the adjustment device has a linear drive which is articulated on the second adjustment arm in order to adjust it along the straight line. The linear drive can be arranged rigidly (i.e. not pivotably) relative to the cargo space. The linear drive can, for example, have a spindle drive. The adjustment of the second adjustment arm along the straight line causes the second adjustment arm to pivot about the mounting point on the adjustment element. The mounting point is thereby adjusted translationally (pushed forward in the direction of travel) due to the second adjustment arm being rigid. The second adjustment arm is adjusted from a position oblique to the cargo space floor, when the adjustment element is in the open position, along an adjustment path which extends in a plane perpendicular to the cargo space floor. A translational adjustment of the adjustment element forward in the direction of travel is at a maximum when the second adjustment arm is arranged parallel to the cargo space floor. Further adjustment of the second adjustment arm allows a translational adjustment of the adjustment element counter to the direction of travel toward the access opening into the closed position.

The fourth variant, in which the adjustment element is adjustable via an adjustment device having at least two adjustment arms that are coupled to one another, can be designed according to a second alternative. As in the first alternative of the fourth variant, the at least two adjustment arms can be pivoted in a plane transverse to the cargo space floor. When the modular assembly is used as intended, the at least two adjustment arms can be arranged inside a body assembly of the motor vehicle by the cargo space assembly. The body assembly may form an edge in front of the access opening of the cargo space over which the adjustment element is adjusted during adjustment between the closed and open positions. To extend the adjustment path for better accessibility of the access opening in the open position, at least two adjustment arms can be angled. At least one angle on the at least two adjustment arms can be designed such that, in the open position of the adjustment element, it is aligned with the edge of the body assembly and/or with a front edge of the hood element in the direction of travel. In this way, the at least two adjustment arms can be angled over the respective edge when the adjustment element is in the open position.

In one embodiment, the at least two adjustment arms each have a first section which is shorter than a second section of the at least two adjustment arms and is arranged at an angle to the second section. The shortness of the first section of the at least two adjustment arms may allow the at least two adjustment arms to be arranged close (along the direction of travel) to the access opening. The relative length of the second section of the at least two adjustment arms can, in contrast, allow the adjustment element to be further toward the access opening in the open position. The first and the second section of the at least two adjustment arms can be arranged at an angle between 80° and 100°, in particular 90°, to one another.

In one embodiment, the second section of the at least two adjustment arms forms an angle of less than 20° with a perpendicular to the cargo space floor in the open position of the adjustment element. In particular, the angle can be less than 10°.

The at least two adjustment arms can be hinged to the adjustment element so that said adjustment element can be moved in parallel (i.e. without changing its orientation) between the closed and the open position. In particular, the at least two adjustment arms can be coupled to one another at at least one of their ends. For example, they can be connected to one another via another adjustment arm. The additional adjustment arm can be rigid and/or shorter than the at least two adjustment arms.

According to the fifth variant, the adjustment element is adjustable via an adjustment device having at least one sliding guide. The adjustment element can be mounted on the at least one sliding guide via a slider. The slider can be designed and provided to slide along the at least one sliding guide for adjusting the adjustment element. The at least one sliding guide can be designed to define any desired adjustment path of the adjustment element. This allows greater flexibility in planning the installation space in a motor vehicle intended for the arrangement of the modular assembly.

The adjustment of the adjustment element by means of the at least one sliding guide can be effected between the closed position, in which the adjustment element closes an access opening to the cargo space, and the open position, in which the adjustment element opens the access opening. The access opening can, for example, be formed by a frame element against which the adjustment element abuts in the closed position. In this case, the frame element can form a completely closed frame in the manner of a window frame, in particular also with a frame section on the side of the hood element. The at least one sliding guide can be designed such that the adjustment element, during adjustment from the open position to the closed position, is guided to abut the frame in a last section of the adjustment path in a direction parallel or perpendicular to a plane defined by the access opening.

In one embodiment, the sliding guide is designed such that the adjustment element in the open position, in which the adjustment element opens the access opening, is arranged below a plane defined by the cargo space floor. This allows the adjustment element to be easily removed from a region through which the user can put objects into the cargo space. In the open position, the adjustment element can be arranged parallel to or at an angle, in particular an angle of 90°, to the cargo space floor. In this respect, the installation space for arranging the adjustment element in the open position can be flexibly provided according to the requirements of the design of the motor vehicle.

For example, in the open position, the adjustment element can be arranged between the frame element and the cargo space floor below the plane defined by the cargo space floor. Alternatively, the adjustment element can be arranged below the cargo space floor in the open position. The at least one sliding guide can be correspondingly extended from the frame element to a receiving region in which the adjustment element is arranged in the open position.

In one embodiment, the at least one sliding guide has a first section along which the adjustment element can be guided along a first direction and a second section along which the adjustment element can be guided along a second direction, wherein the second direction is arranged obliquely to the first direction. The first and the second section of the at least one sliding guide can therefore be arranged at an angle to one another. In particular, the angle between the sections of the at least one sliding guide can be 90°.

The at least one sliding guide can extend in a plane transverse to the cargo space floor. The guidance of the adjustment element on the at least one sliding guide can be designed such that the adjustment element is rotated about an axis transverse to the adjustment direction during the adjustment along the at least one sliding guide. Alternatively, the sliding guide can be designed such that an orientation of the adjustment element in the open position is parallel to an orientation of the adjustment element in the closed position.

In one embodiment, at least two sliding guides are provided on which the adjustment element is adjustably mounted via a single slider. The at least two sliding guides can thus be connected via the slider. This allows the orientation of the adjustment element relative to the sliding guides to be determined. This determination of the orientation can allow a parallel adjustment of the adjustment element. The at least two sliding guides can in particular have an identical shape. In addition, the at least two sliding guides can be arranged offset from one another. The offset of the at least two sliding guides relative to one another can be provided in an adjustment plane which is defined by the adjustment arms of the adjustment element.

In an alternative embodiment, two sliders are provided via which the adjustment element is adjustably mounted on the at least one sliding guide. The sliders can be coupled together via the adjustment element. If the at least one sliding guide is angled, the use of two sliders can allow rotation of the adjustment element during the (translational) adjustment between the open and the closed position. This allows the adjustment element to be easily concealed under the cargo space. In particular, this can prevent unintentional collisions with elements of the vehicle body.

The adjustment movement of an adjustment element mounted on at least one sliding guide can be provided, for example, by a drive motor. For example, a drive force generated by the drive motor can be transmitted to the adjustment element via a flexible traction means (for example a wire, a Bowden cable, a cable or a cord) in order to effect the adjustment. Alternatively, (scissor) arms driven by a drive motor in the manner of a window lifter can be provided for adjustment.

The adjustment can be made independently of any adjustment of the hood element. In particular, it is not absolutely necessary for the hood element to be adjusted or even lifted in order to be able to adjust the adjustment element. A separately accessible section of the cargo space may therefore be provided which is only accessible via the access opening and not via the loading opening. In addition, the use of at least one sliding guide allows the adjustment element to be lowered relative to the access opening so that said access opening is freely accessible without the adjustment element projecting in the direction of the access opening in a region in front of or behind the access opening.

According to another embodiment of the fifth variant, in which the adjustment element is adjustable via an adjustment device having at least one sliding guide, the at least one sliding guide has a constant curvature or is straight. A radius of curvature of at least one sliding guide can be more than 1 m (in a plane transverse to the cargo space floor). With such a longitudinally extending at least one sliding guide, a secure mounting of the adjustment element can be achieved. On the side of the adjustment element, a slider can be provided which is associated with at least one sliding guide and which can also be longitudinally extended. For example, the at least one sliding guide can engage with the at least one slider in order to guide the adjustment element relative to the cargo space. The length of the at least one sliding guide and of the associated slider can correspond to a length of the adjustment element along an adjustment path of the adjustment element.

In one embodiment, the at least one sliding guide is formed integrally with a cargo space wall which projects up from the cargo space floor. For example, the at least one sliding guide at the access opening may project from the cargo space wall in a direction that points away from the access opening. The associated slider may be arranged on an edge of the at least one sliding guide that points away from the access opening. The one-piece design of the at least one sliding guide with the cargo space wall can have the advantage that the at least one sliding guide can be provided in a simple manner without an additional component. In principle, the at least one sliding guide can be designed as a separate part that can be arranged on the cargo space wall or on another component of the modular assembly that is kinematically connected to the cargo space, or can be arranged on the motor vehicle in which the modular assembly can be arranged. The adjustment of the adjustment element along the at least one sliding guide can be effected in any way.

In one embodiment, the adjustment device has an adjustment assembly with a flexible traction means that can be driven by a traction means drive for adjusting the adjustment element. Making the adjustment with the flexible traction means can have the advantage that the adjustment can be carried out quickly and with a smooth adjustment movement, which can improve the user experience when using the modular assembly. The adjustment assembly can be designed like a window lifter. The flexible traction means can be deflected at at least one or at least two deflection elements. In addition, the adjustment element can be entrained by the traction means via a traction means entrainment lug which is fixedly connected to the traction means. For this purpose, the adjustment element can be mounted on the traction means entrainment lug. Furthermore, the adjustment assembly can have a traction means drive, for example in the form of an electric motor, by means of which the flexible traction means can be driven. The flexible traction means can extend in or parallel to a plane defined by the adjustment path of the adjustment element (or a part thereof). The traction means drive can, for example, be a self-locking drive.

According to a further embodiment of the third variant, the adjustment element is mounted so as to be pivotable about an axis of rotation relative to the cargo space, wherein at least one adjustment arm is provided on the adjustment element and can be actuated via a linear drive to pivot the adjustment element. In this variant, the mounting can be eccentric in relation to the axis of rotation. For this reason, this variant can be designed in particular according to the features and their advantages described above in connection with the eccentric mounting. This relates in particular to the design of the pivot element and to the designs of the floor element, the bridging device and the entrainment device.

The at least one adjustment arm can provide a simple and safe way to adjust the adjustment element. For example, the at least one adjustment arm can engage an end of the adjustment element facing the cargo space (in the open position). One adjustment arm can project from the adjustment element. The linear drive can engage at its free end. The at least one adjustment arm can thus provide a lever for actuating the adjustment element.

In the open position, the at least one adjustment arm can be arranged parallel to the cargo space floor along a section corresponding to more than 50% of its length. This can improve safety when using the modular assembly. In the closed position, the section corresponding to more than 50% of its length may be arranged perpendicular to the cargo space floor. During adjustment between the open and closed positions, at least one adjustment arm can be adjusted by at least 90°. An adjustment path of the at least one adjustment arm between the open and the closed position can extend along a circular arc about the axis of rotation. The at least one adjustment arm can extend in a plane that is arranged transversely to the axis of rotation.

In one embodiment, the at least one adjustment arm has an engagement section, via which the at least one adjustment arm engages the adjustment element, and an actuating section, via which the at least one adjustment arm can be actuated by the linear drive, wherein the engagement section and the actuating section can be at a distance from one another by an angle of more than 45°, in particular more than 100°, with respect to the axis of rotation. Such a distance between the engagement section and the actuating section can allow effective actuation of the at least one adjustment arm. Relative to a projection onto a plane along which the cargo space floor extends, the axis of rotation can be arranged in the open position between the engagement section and the actuating section. An adjustment of the actuating section in a first direction can thus cause an adjustment of the adjustment element in a second direction which is opposite the first direction.

At least one pivot element can be provided which is pivotally mounted on the axis of rotation and on which the adjustment element is arranged on a connecting section of the pivot element which is at a distance from the axis of rotation. The connecting section can be connected via a curved connecting arm to a mounting section of the at least one pivot element, on which mounting section the at least one pivot element is mounted on the axis of rotation. For example, the connecting arm can be angled (e.g. at an angle of less than 90°). In a cross-section transverse to the axis of rotation, the connecting arm can have a wedge shape. It is also conceivable and possible for the connecting arm to be curved. An advantage of an angled design is that the connecting arm can better support the adjustment element and/or the floor element in the open position if the section of the connecting arm facing the adjustment element is designed in the open position parallel to a plane defined by the cargo space floor. In particular, a flat design of this section is suitable for this purpose.

In one embodiment, a flexible or rigid stop element is provided which is connected at one end to the actuating section and at the other end is kinematically connected to the cargo space. For example, the stop element may comprise a wire, a cord or a rod. The stop element may have a length corresponding to a distance between its connection point on the cargo space side and the actuating section when the adjustment element is in the open position. If misuse forces act on the adjustment element in a direction that causes an adjustment from the closed position to the open position and beyond, the stop element can thus prevent a further adjustment of the adjustment element. This can increase safety during use of the modular assembly. In the closed position of the adjustment element, the stop element can be loose, while in the open position of the adjustment element it can be tightened. In particular, the linear drive can engage a first adjustment arm and the stop element can engage a second adjustment arm. An engagement of a further linear drive on the second adjustment arm can optionally be provided.

In one embodiment, a translation axis along which the linear drive is adjustable for adjusting the at least one adjustment arm forms an angle of less than 45° with a perpendicular to the cargo space floor. When the modular assembly is used as intended in a motor vehicle, this may mean that the linear drive is arranged transversely to the direction of travel of the motor vehicle. Collision forces that may arise in the event of a collision of the motor vehicle along the direction of travel will thus act transversely to the translation axis, so that safety is increased compared to a linear drive arranged parallel to the direction of travel. For example, if the linear drive comprises a spindle, this can increase the safety of vehicle occupants in the event of a collision.

The linear drive can be pivotally mounted on the cargo space. The translation axis can therefore be pivoted. This can allow an adjustment of at least one adjustment arm when a linear force is introduced along a circular path about the axis of rotation. For example, the linear drive can be arranged on a section of the cargo space wall that is adjacent to the access opening. During adjustment from the open to the closed position, the linear drive can apply an adjusting force along the translation axis which is directed toward a side of the cargo space floor facing away from the cargo space. This allows the adjustment of the adjustment element from the open to the closed position. The at least one adjustment arm can thereby be guided along a circular path about the axis of rotation, so that in the closed position of the adjustment element it is arranged completely or at least partially on a side of a plane which is defined by the cargo space floor, and which is remote from the cargo space. During adjustment from the closed position to the open position of the adjustment element, the linear drive can move at least one adjustment arm along the circular path in the opposite direction.

It is not absolutely necessary to operate the hood element when adjusting the adjustment element in this way.

According to the sixth variant, the adjustment element is pivotally mounted relative to the cargo space about an axis of rotation which divides the adjustment element into a first and a second section. The adjustment element can therefore be arranged relative to the axis of rotation in such a way that the axis of rotation intersects the adjustment element. The first section of the adjustment element can, for example, be arranged on the side of the cargo space in the closed position of the adjustment element and the second section on a side of the axis of rotation facing away from the cargo space.

In one embodiment, the first section of the two sections into which the axis of rotation divides the adjustment element is provided for closing the access opening (and possibly for sealing it) and the second section is arranged next to the access opening in a direction transverse to the axis of rotation in the closed position of the adjustment element in which it closes the access opening. For example, the axis of rotation can be arranged in a plane with the cargo space floor or at least in a plane parallel to the cargo space floor. The first section may be arranged above the level in the closed position, and the second section may be arranged below this level. The adjustment element can thus cover a larger area when viewed from the outside than is defined by the access opening. This allows for more flexibility in the design of the adjustment element.

In the open position, the first section can serve to extend the cargo space floor and, when the modular assembly is used as intended in a motor vehicle, can be arranged in front of the access opening in the direction of travel. In the open position, the second section can be stowed on a side of the cargo space floor facing away from the cargo space. A storage space can be provided in the motor vehicle below the cargo space for the second section of the adjustment element.

In particular, the axis of rotation can divide the adjustment element into two sections whose lengths transversely to the axis of rotation are equal. The axis of rotation can therefore cut through the adjustment element in the middle.

The adjustment of the adjustment element can be carried out via an adjustment drive, which acts directly on the adjustment element via an adjustment gear. Because a simple rotary adjustment drive is sufficient for the adjustment of the adjustment element, the installation space required for the adjustment device of the adjustment element can be optimized and the user experience when using the modular assembly can be improved because such a drive is robust and stable. If necessary, an (in some cases flexible) stop element can be provided to limit the adjustment movement of the adjustment element.

The proposed solution also concerns a motor vehicle comprising a modular assembly.

### BRIEF DESCRIPTION OF THE DRAWINGS

The idea on which the proposed solution is based will be explained in more detail below with the aid of the exemplary embodiments shown in the figures. In the figures:

FIG. 1 is a view of a motor vehicle comprising a modular assembly;

FIG. 2 is a view of a modular assembly comprising an adjustment element, which has a first and a second section;

FIGS. 3A and 3B are views of a motor vehicle in which a modular assembly having four adjustment arms is arranged;

FIGS. 4A and 4B are views of a modular assembly comprising a floor element;

FIGS. 5A to 6B are views of a modular assembly comprising a bridging assembly;

FIGS. 7A and 7B are views of a modular assembly comprising a translationally adjustable floor element;

FIGS. 8A and 8B are views of a modular assembly comprising a floor element adjustable via two coupled adjustment arms;

FIG. 9 is a view of a motor vehicle comprising a modular assembly with a plurality of adjustment arms;

FIG. 10 is a sectional view through the motor vehicle of FIG. 9;

FIGS. 11A and 11B are views of a motor vehicle comprising a modular assembly with a plurality of adjustment arms;

FIG. 12 is a view of a motor vehicle comprising a modular assembly with a plurality of alternative adjustment arms;

FIG. 13 is a sectional view through the motor vehicle of FIG. 12;

FIGS. 14A and 14B are views of a motor vehicle comprising an adjustment element which is kinematically connected to the hood element;

FIGS. 15A to 15C are views of a motor vehicle comprising a modular assembly with two sliding guides;

FIG. 16 is a sectional view through the motor vehicle of FIG. 15C;

FIGS. 17A to 17C are views of a motor vehicle comprising a modular assembly with a sliding guide;

FIG. 18 is a sectional view through the motor vehicle of FIG. 17A;

FIGS. 19A and 19B are views of a modular assembly comprising flexible traction means for adjusting the adjustment element;

FIG. 20 is a further view of the modular assembly of FIG. 19A;

FIG. 21 is a sectional view through the modular assembly of FIG. 19A;

FIG. 22 is a view of a modular assembly comprising adjustment arm and linear drive, with the adjustment element in the open position;

FIG. 23 is a view of a modular assembly comprising adjustment arm and linear drive, with the adjustment element in the closed position;

FIGS. 24A and 24B are views of a motor vehicle comprising a modular assembly with a linear drive;

FIG. 25 is a view of a motor vehicle comprising a modular assembly with a stop element;

FIG. 26 is a view of a motor vehicle comprising a modular assembly with a holding device;

FIGS. 27A and 27B are detailed views of an adjustment arm and stop element;

FIGS. 28A to 28D are views of a motor vehicle with a modular assembly with a hood element and adjustment element in different positions;

FIGS. 29A to 29C are views of a motor vehicle with a modular assembly with a hood element and adjustment element in different positions; and, FIGS. 30A and 30B are views of a motor vehicle comprising a modular assembly with an adjustment element that can be pivoted about an axis of rotation.

### DETAILED DESCRIPTION OF THE INVENTION

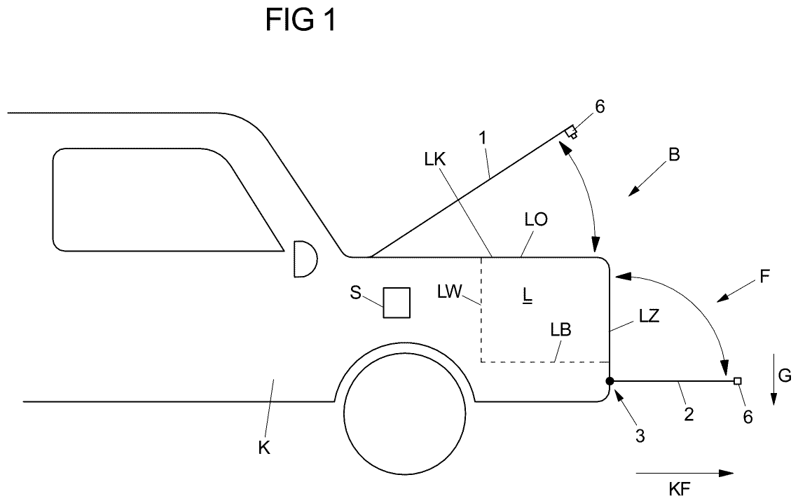

FIG. 1 shows a view of a motor vehicle K comprising a modular assembly B. The modular assembly B has a cargo space L for storing objects in the manner of a front trunk (in German shortened to “frunk”). The cargo space is located at the front of the motor vehicle K, viewed along the direction of travel KF. The cargo space L comprises a cargo space floor LB, upward from which a cargo space wall LW projects, forming an enclosure for the cargo space L. It is conceivable and possible for the cargo space wall LW to be designed in sections along and/or transverse to the earth's gravity line G. For example, the cargo space wall LW can have steps whose shoulders are formed transversely to the earth's gravity line G. Objects can be brought into the cargo space L via a loading opening LO over a cargo space edge LK in order to store them on the cargo space floor LB (or on the steps of the cargo space wall LW). The loading opening LO is arranged opposite the cargo space floor LB and is spaced apart from it at least by the cargo space wall LW.

The loading opening LO can be closed via a hood element 1 which is arranged above the loading opening LO (relative to the earth's gravity line G). The hood element 1 is arranged so as to be pivotable relative to the cargo space L. In addition to the loading opening LO, the cargo space L has an access opening LZ, which is provided in the cargo space wall LW. Alternatively, this can be provided in a separate frame element LR, which is located in front of the cargo space L in the direction of travel KF. The adjustment element 2 is arranged on a front section F of the motor vehicle K. The front section F faces forward in the direction of travel KF. In particular, the front section F is arranged in front of the hood element 1 along the direction of travel KF. The front section F creates a frontal appearance, a “face” of the motor vehicle K (possibly together with vehicle lights).

The access opening LZ can be closed by means of an adjustment element 2. For closing, the adjustment element 2 can be adjusted between an open and a closed position. The adjustment element 2 is arranged on the same level as the cargo space L with respect to the earth's gravity line G. In particular, it is located below the hood element 1. The access opening LZ is located in front of the loading opening LO in the direction of travel. Both openings LZ, LO can together form a total opening to the cargo space L. The hood element 1 is adjustable along an adjustment path between a closed position in which the loading opening LO is closed, to an open position in which the loading opening LO is open for depositing objects in the cargo space L.

The hood element 1 and the adjustment element 2 can be locked against a body assembly of the motor vehicle K or against one another via a locking device 6 in order to prevent unauthorized opening. The locking device 6 can be designed such that the adjustment element 2 cannot be adjusted without unlocking the hood element 1 (and/or that the hood element 1 cannot be adjusted without unlocking the adjustment element 2). This may make it necessary to adjust the hood element 1 in order to adjust the adjustment element 2. In principle, the locking device 6 can be designed such that the hood element 1 is secured with the adjustment element 2, so that the adjustment element 2 can be adjusted independently of the hood element 1.

The modular assembly B further comprises an electronic control unit S which is provided and configured to release an adjustment movement of the hood element 1 and/or of the adjustment element 2, for example upon actuation by the user. For example, the electronic control unit S can be configured and provided in such a way that the hood element 1 is adjusted together with the adjustment element 2 and/or that the hood element 1 is adjusted by a portion of less than 10% of its adjustment path when the adjustment element 2 is to be adjusted from the closed to the open position in order to unlock the locking device 6. Likewise, the electronic control unit S can be designed and provided so that the hood element 1 and the adjustment element 2 can each be adjusted independently of one another. In particular, the electronic control unit S can be designed in such a way that the user can select between a joint and an individual adjustment of the hood element 1 and the adjustment element 2.

The adjustment element 2 is mounted relative to the cargo space L via an adjustment device 3, which here comprises, for example, a simple swivel joint. Different adjustment devices 3, by means of which the adjustment element 2 can be adjusted, are described below.

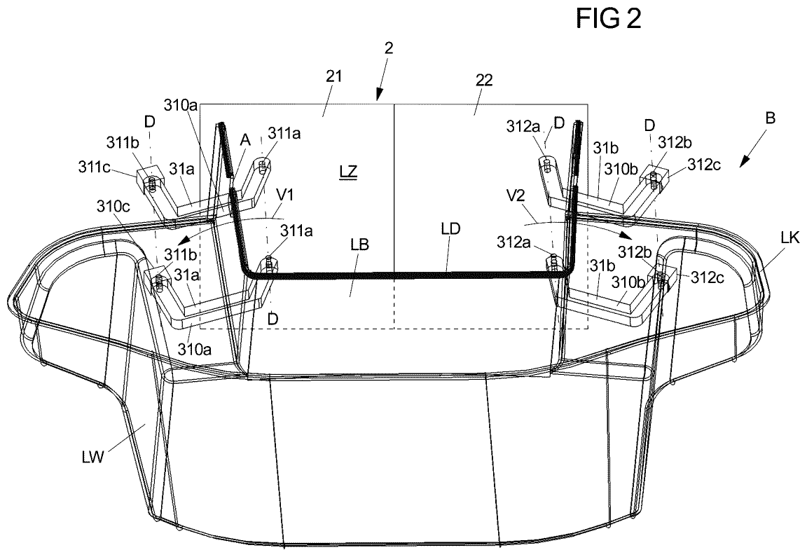

FIG. 2 shows a view of an exemplary embodiment of the modular assembly B comprising an adjustment element 2, which has a first and a second section 21, 22. In the closed position shown, the sections of the adjustment element 21, 22 abut one another along a dividing plane perpendicular to the cargo space floor LB (and parallel to the direction of travel). In particular, the sections of the adjustment element 21, 22 abut one another along a dividing axis perpendicular to the cargo space floor LB. Alternatively, the dividing axis may be oriented obliquely, in particular at an angle of less than 10°, to the cargo space floor LB. In the open position, sections 21, 22 are at a distance from one another in order to open the access opening LZ. To adjust each section 21, 22, the modular assembly B has two adjustment arms 31a, 31b, whereby in principle one adjustment arm 31a, 31b is sufficient for each section of the adjustment element 21, 22. The sections of the adjustment element 21, 22 can be adjusted in a plane parallel (or alternatively at an angle) to the cargo space floor LB via the adjustment arms 31a, 31b. The adjustment here comprises pivoting the sections of the adjustment element 21, 22 in a pivoting plane parallel (or alternatively obliquely) to the cargo space floor LB. Accordingly, adjustment paths V1, V2, along which the sections of the adjustment element 21, 22 are adjustable, extend in the pivoting plane.

The adjustment arms 31a, 31b are each pivotally connected to the sections of the adjustment element 21, 22 at first mounting points 311a, 312a. This allows an orientation of sections 21, 22 relative to the cargo space L to be kept constant during the adjustment movement. In addition, the adjustment arms 31a, 31b are each mounted opposite the cargo space L via a second mounting point 311b, 312b on a mounting base 311c, 312c, which is fixed to the cargo space. The adjustment arms 31a, 31b are rotatably mounted on the mounting base 311c, 312c via the second mounting points 311b, 312b. At the mounting points 311a, 311b, 312a, 312b, the adjustment arms 31a, 31b are rotatably mounted about axes of rotation D, which are perpendicular to the cargo space floor LB.

The adjustment arms 31a, 31b each have a central section 310a, 310b, from which mounting sections, at each end of which a mounting point 311a, 311b, 312a 312b is provided, project at an obtuse angle. With the central section 310a, 310b, two of the adjustment arms 31a (the adjustment arms 31a, 31b arranged above along the earth's gravity line) engage in a recess A in the cargo space wall LW. By the engagements in the recess A, installation space can be saved. When adjusting from the closed to the open position, the adjustment arms 31a, 31b are adjusted by an angle of less than 90°. The central section 310a, 310b of the adjustment arms 31a thereby disengages from the recess A.

A sealing element LD is provided at the access opening LZ, against which sealing element the adjustment element 2 abuts in the closed position in order to seal the cargo space L off from a wet region.

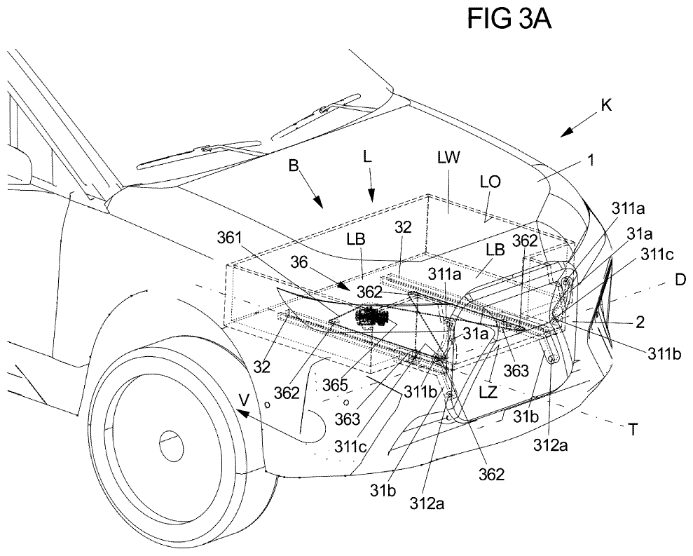

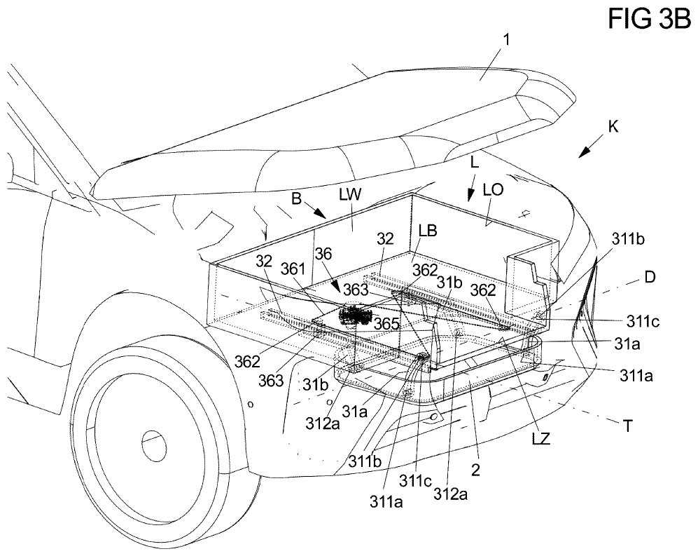

FIG. 3A and FIG. 3B show perspective views of a motor vehicle K in which a modular assembly B having a loading opening LO and an access opening LZ is arranged. In FIG. 3A, the loading opening LO is closed by a hood element 1. The access opening LZ is closed by the adjustment element 2. In FIG. 3B, the loading opening LO is open because the hood element 1 is adjusted to an open position. In addition, the access opening LZ is also open because the adjustment element 2 is adjusted to an open position. The adjustment element 2 is mounted on two first and two second adjustment arms 31a, 31b.

The first adjustment arm 31a allows a rotational adjustment of the adjustment element 2. The second adjustment arm 31b allows a translational adjustment of the adjustment element 2. During an adjustment movement of the adjustment element 2, the first adjustment arm 31a and the second adjustment arm 31b interact, so that the adjustment element 2 is positively guided along an adjustment path V, which comprises a combined rotational and translational adjustment movement.

The first adjustment arm 31a is arranged on a section of the cargo space wall LW which is formed transversely to the access opening LZ. This makes it possible to pivot in a pivoting plane transverse to the access opening LZ. The first adjustment arm 31a has an arcuate shape. In principle, the first adjustment arm 31a can be shaped as desired. The first adjustment arm 31a has a first mounting point 311a via which the first adjustment arm 31a is articulated to the adjustment element 2. In addition, the first adjustment arm 31a has a second mounting point 311b via which the first adjustment arm 31a is arranged to be rotatable relative to the cargo space L. In the present case, the second mounting point 311b is rotatably connected to a mounting base 311c.

The second adjustment arm 31b is arranged on a side of the cargo space floor LB facing away from the cargo space wall LW. For the translational guidance of the second adjustment arm 31b, a guide assembly 32 is provided which has a guide rail. The second adjustment arm 31b has a first section on which a mounting point 312a is provided and via which the second adjustment arm 31b is rotatably connected to the adjustment element 2. In addition, the second adjustment arm 31b has a second section via which the second adjustment arm 31b is guided on the guide assembly 32. The first and second sections of the second adjustment arm 31b are formed at an angle to one another. In particular, an obtuse angle is provided between the two sections of the adjustment arm 31b.

For adjusting the adjustment element 2, an adjustment assembly 36 is provided which engages at least one of the second adjustment arms 31b. In this case, the adjustment assembly 36 engages both second adjustment arms 31b. For adjusting the second adjustment arm 31b, the adjustment assembly 36 comprises a flexible traction means 361. The flexible traction means 361 extends in a plane parallel to the cargo space floor LB. The adjustment assembly 36 is arranged on the side of the cargo space floor LB facing away from the cargo space L. The flexible traction means 361 is deflected via at least one deflection element 362. In the present case, four deflection elements 362 are provided, at which the flexible traction means 361 is deflected. Two first deflection elements 362 are arranged on the guide assembly 32 of the one second adjustment arm 31b. Two second deflection elements 362 are arranged on the guide assembly 32 of the other second adjustment arm 31b. The traction means 361 has two sections, each extending parallel to one of the guide assemblies 32. At each of these sections, a traction means entrainment lug 363 is provided via which the relevant second adjustment arm 31b is entrained during the adjustment of the traction means 361. For this purpose, the second adjustment arm 31b is coupled to the traction means entrainment lug 363.

The flexible traction means 361 extends from a deflection element 362 of the first deflection elements 362 arranged on the side of the access opening LZ to a deflection element 362 of the second deflection elements 362, which is spaced further apart from the access opening LZ than the other of the second deflection elements 362. Likewise, the flexible traction means 361 extends from a deflection element 362 of the second deflection elements 362 arranged on the side of the access opening LZ to a deflection element 362 of the first deflection elements 362 which is spaced further apart from the access opening LZ than the deflection element 362 of the first deflection elements 362 arranged on the side of the access opening LZ. Due to the arrangement, the traction means 361 crosses itself between the guide assemblies 32.

The adjustment of the flexible traction means 361 is effected via a traction means drive 365. This can, for example, have an electric motor.

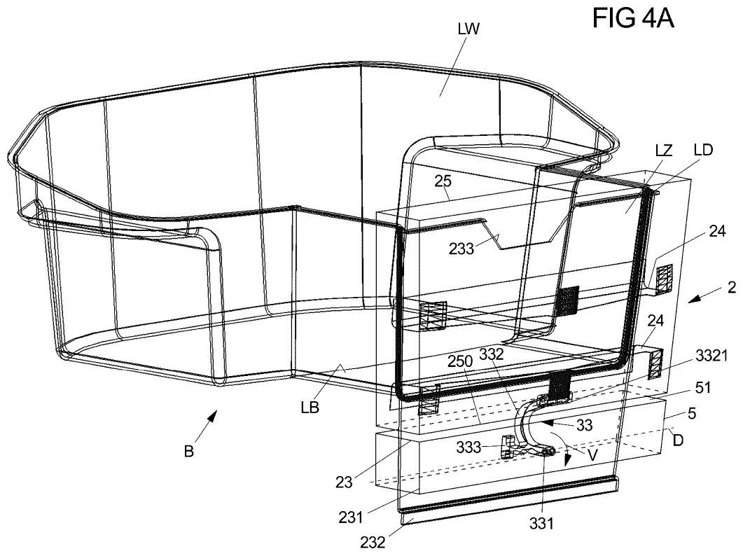

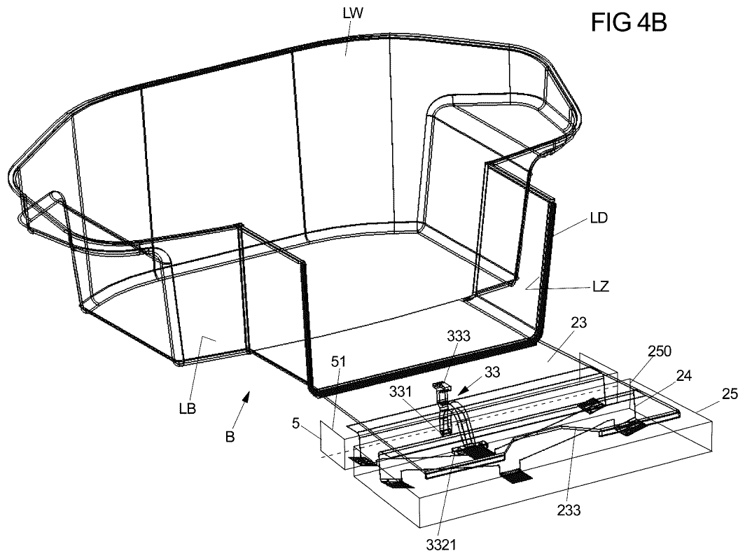

FIG. 4A and FIG. 4B each show perspective views of a modular assembly B, in which the adjustment element 2 has a floor element 23 with which the access opening LZ is closed in a closed position of the adjustment element 2 (FIG. 4A) and which, in an open position in which the access opening LZ is open, is provided for extending the cargo space floor LB (FIG. 4B). The floor element 23 thus has a dual function in this exemplary embodiment. In principle, the floor element 23 can alternatively be provided for only one of the two functions. For example, the access opening LZ can be closed by a trim element 25 or another element in the closed position of the adjustment element 2 and the floor element 23 can nevertheless be provided in the open position to extend the cargo space floor LB. In contrast, providing the floor element 23 with two functions can save installation space.

The floor element 23 has an engagement recess 233, which can be used, for example, to provide a locking device 6 or for manually actuating the adjustment element 2. In the closed position of the adjustment element 2, the engagement recess 233 is provided on a side of the floor element 23 facing away from the cargo space floor LB.

The adjustment element 2 is pivotally mounted on an axis of rotation D via a pivot element 33. The adjustment element 2 is arranged via the pivot element 33 at a distance from the axis of rotation D on a connecting section 3321 of the pivot element 33. When pivoting, the adjustment element 2 is therefore moved on a circular adjustment path V about the axis of rotation D. The pivot element 33 has a connecting arm 332 via which the connecting section 3321 is connected to a mounting section 331 of the pivot element 33 on which the pivot element 33 is mounted on the axis of rotation D. The connecting arm 332 is curved. The curvature is convex toward the floor element 23.

The adjustment element 2 has a trim element 25 via which the adjustment element 2 is connected to the pivot element 33. The floor element 23 is arranged on the trim element 25 via a carrier element 24. In principle, the adjustment element 2 can be connected to the pivot element 33 via the carrier element 24 or the trim element 25. The trim element 25 has an end section 250 which is arranged along an axis perpendicular to the axis of rotation D between the connecting section 3321 and the axis of rotation D. The end section 250 of the trim element 25 forms an (at least partial) fairing around the floor element 23. The connecting section 3321 of the pivot element 33 is arranged within the fairing. A contour of the end section 250 thus comprises a section extending longitudinally along the axis of rotation D and two (optional) sections extending transversely to the axis of rotation D therefrom. Because the connecting section 3321 is arranged within the fairing, it is concealed from the outside by the trim element 25, which can improve the appearance of the modular assembly B.

Furthermore, the modular assembly B has a terminating element 5. The terminating element 5 has a head section 51 which, in the closed position of the adjustment element 2, abuts the end section 250 of the trim element 25. A contour of the head section 51 corresponds to a contour of the end section 250. In the closed position, the terminating element 5 thus forms a single-piece element with the trim element 25. The terminating element 5 can be made of the same material as the trim element 25.

The terminating element 5 is arranged on a side of the access opening LZ facing away from the cargo space floor LB (lying in front of the cargo space floor LB in the direction of travel). The axis of rotation D about which the pivot element 33 can be pivoted is arranged between the terminating element 5 and the access opening LZ. The axis of rotation D is arranged along a direction perpendicular to the cargo space floor LB at the same height as the terminating element 5. The mounting section 331 of the pivot element 33 is therefore hidden within the terminating element 5 so that it is not visible from the outside. Together with the trim element 25, the terminating element 5 thus conceals the pivot element 33 in the closed position of the adjustment element 2.

Due to the curved shape of the connecting arm 332 of the pivot element 33, the trim element 25 can be pivoted over the head section 51 of the terminating element 5 when the adjustment element 2 is adjusted from the closed to the open position. The provision of the pivot element 33 with the curved connecting arm 332 is thus an option for providing a horizontally divided overall element (which can be designed, for example, as a radiator grille or as a decorative element), the upper section of which is adjustable in the form of the trim element 25 in order to open the access opening LZ. The upper section can make up 70% of the height of the entire element. With such an arrangement of trim element 25 and pivot element 33, a floor element 23 of any design can optionally be provided.

In the open position of the adjustment element 2 shown in FIG. 4B, the cargo space floor LB is extended by the floor element 23. In this case, a step section 232 of the floor element 23 comes into abutment with the cargo space floor LB, wherein the step section 232 engages under the cargo space floor LB. A loading section 231 of the floor element 23, which adjoins the step section 232, extends the cargo space floor LB forward in the direction of travel. The pivot element 33 has a support arm 333 with which the floor element 23 is supported in the direction of the axis of rotation D in the open position, so that a user can also place heavy objects on it. The support arm 333 can be shaped such that a support position for the floor element 23 at which the support arm 333 abuts the floor element 23 (projected onto the plane of the floor element 23) is closer to the cargo space floor LB than the axis of rotation D. In particular, the support arm 333 has a first section which is formed transversely to the floor element 23 and a second section which is formed perpendicular to the floor element 23. The support arm 333 is thus angled.

The floor element 23 of the exemplary embodiment of FIGS. 4A and 4B docks in the open position to extend the cargo space floor LB directly (if necessary via an optional step section 232) to the cargo space L. This provides a simple way of extending the cargo space floor LB. In the closed position, the floor element 23 is longer than the access opening LZ along an axis perpendicular to the cargo space floor LB. For the floor element 23, a relatively long installation space must therefore be provided in the motor vehicle K for stowing the floor element 23 below the cargo space L when used as intended in a motor vehicle K.

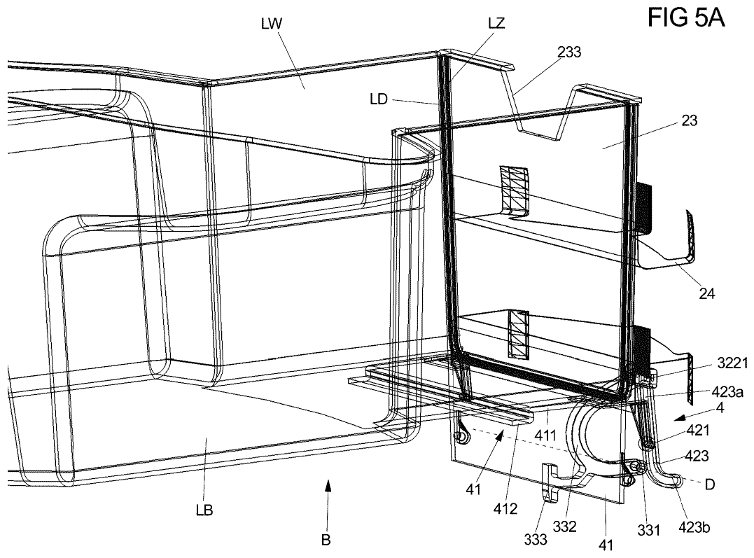

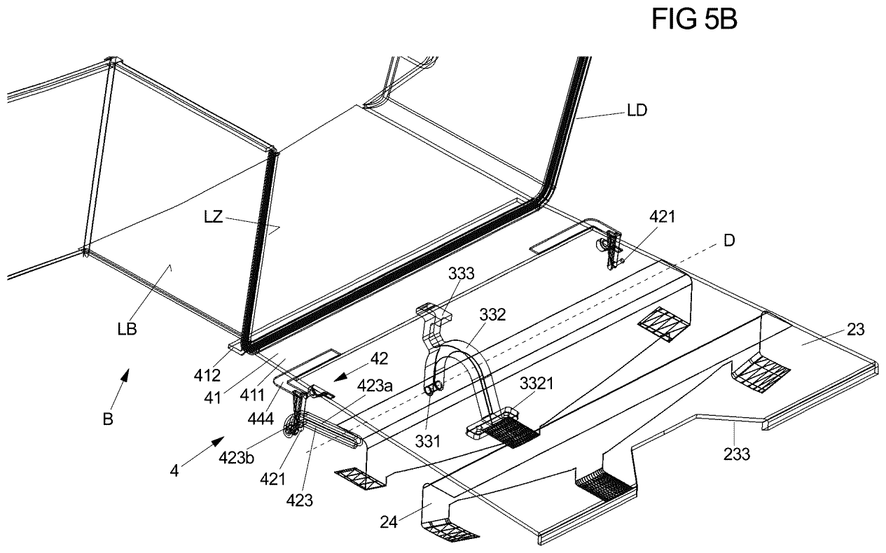

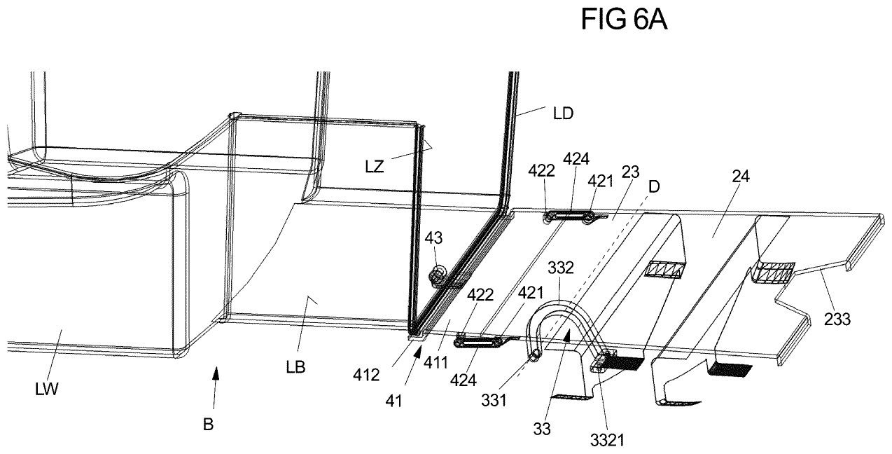

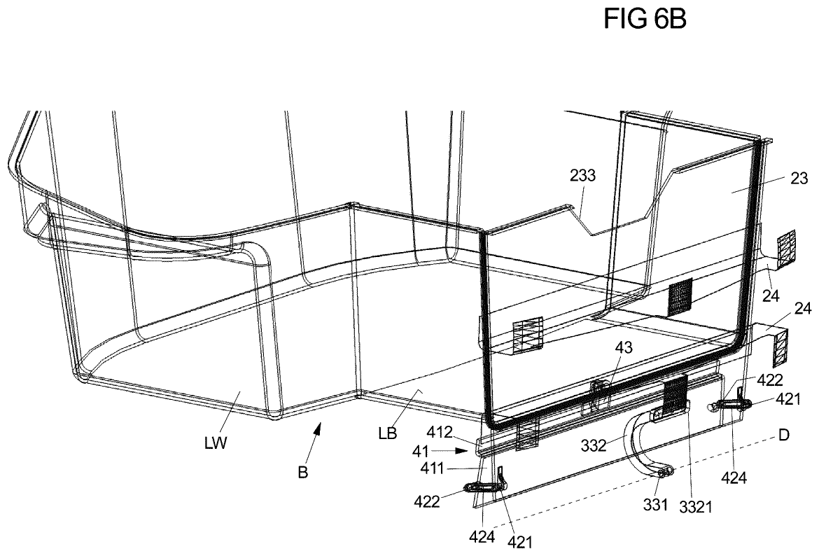

The exemplary embodiments in FIGS. 5A to 6B show a possibility for shortening the length of the installation space to be provided below the cargo space L and yet providing a generous extension of the cargo space floor LB in the open position. For this purpose, the floor element 23 is shortened and a bridging assembly 4 is provided via which the floor element 23 docks to the cargo space L. In the open position, this serves in addition to the floor element 23 to extend the cargo space floor LB. The bridging assembly 4 has a floor element 23 and an entrainment device 42 via which the bridging element 41 can be entrained by the adjustment element 2 during the adjustment of the adjustment element 2. An advantage of using the bridging assembly 4 is that the modular assembly B allows more flexibility in the design of the installation space in the motor vehicle K, because the bridging element 41 can be stowed in any desired stowage position relative to the cargo space L. Specifically, the bridging element 41 can be arranged at any angle to the cargo space floor LB in the closed position of the adjustment element 2. For example, it can be stowed parallel to the cargo space floor LB, at an obtuse angle to the cargo space floor LB, or at any angle in between below the cargo space floor LB. Such a variety of possibilities for stowing the bridging element 41 can be achieved by different designs of the entrainment device 42. The following two exemplary embodiments show two exemplary carrier devices 42, which allow stowage parallel to the cargo space floor LB and at an acute angle to the cargo space floor LB, in each case below the cargo space floor LB

The exemplary embodiment in FIGS. 5A and 5B comprises an entrainment device 42 having an entrainment lug 421 arranged on the bridging element 41 and a guide element 423 arranged on the adjustment element 2. In principle, the guide element 423 can alternatively be arranged on the bridging element 41 and the entrainment lug 421 on the adjustment element 2. However, the design shown of the guide element 423 is suitable for arrangement on the adjustment element 2.

The entrainment lug 421 is pin-shaped and engages in the guide element 423 designed as a slotted guide. During adjustment of the adjustment element 2, the bridging element 41 is thus positively guided on the guide element 423 via the entrainment lug 421. The entrainment lug 421 is arranged on the bridging element 41 via a holder 444. By means of the holder 444, the entrainment lug 421 is arranged offset relative to the bridging element 41 toward the axis of rotation D. As a result, the entrainment lug 421 is arranged along the cargo space floor LB in front of the bridging element 41 and is arranged transversely to the cargo space floor LB below the bridging element 41. The entrainment device 42 can thus be arranged, in particular, in the open position of the adjustment element 2 relative to the floor element 23 and the bridging element 41 on the side of the axis of rotation D, so that accidental damage caused by storing objects thereon is prevented.

The floor element 23 is adjustable by the entrainment device 42 between a stowed position in the closed position of the adjustment element 2 and a functional position in the open position of the adjustment element 2. The stowage position is provided below the cargo space floor LB parallel to the cargo space floor LB. In the functional position, the bridging element 41 bridges a gap between the floor element 23 and the cargo space floor LB. The adjustment of the bridging element 41 takes place exclusively in a translational manner. The bridging element 41 has a loading section 231 and a step section 232, wherein the step section 232 abuts the sealing element LD of the cargo space L in the open position of the adjustment element 2.

The translational movement of the bridging element 41 guided by the pivoting movement of the adjustment element 2 is made possible by the fact that the guide element 423 is L-shaped. The guide element 423 has a first entrainment section 423a and a second entrainment section 423b. When the adjustment element 2 is adjusted from the closed to the open position, the entrainment lug 421 is entrained by the first entrainment section 423a and is displaced by the adjustment to the second entrainment section 423b. During the adjustment from the open to the closed position, the entrainment lug 421 is entrained by the second entrainment section 423b and is displaced to the first entrainment section 423a by the adjustment. The entrainment sections 423a, 423b are arranged obliquely, in particular at right angles, to one another. In the open position of the adjustment element 2, the first entrainment section 423a is further away from the access opening LZ than is the second entrainment section 423b.

The support arm 333 of the pivot element 33 is configured and provided in such a way that in the open position of the adjustment element 2, the bridging element 41 and the floor element 23 abut the support arm 333. The support arm 333 supports the loading surface formed by the floor element 23 and the bridging element 41 at the transition between the floor element 23 and the bridging element 41. This allows the loading surface to be secured effectively.

The exemplary embodiment in FIGS. 6A and 6B comprises an entrainment device 42 with two rigid coupling elements 424, each of which couples to the other a first entrainment lug 421 on the adjustment element 2 and a second entrainment lug 422 on the bridging element 41. The bridging element 41 is pivotally mounted on the cargo space L via a bridge base 43. The bridge base 43 is arranged below the access opening LZ in such a way that the bridging element 41 can be pivoted in the open position of the adjustment element 2 into a functional position in which the bridging element 41 extends the cargo space floor LB. The bridging element 41 has a step section 232 with which the bridging element 41 engages under the cargo space floor LB and which the sealing element LD of the cargo space L abuts. The extension of the cargo space floor LB is effected via a loading section 231 of the bridging element 41.

In principle, one coupling element 424 is sufficient to entrain the bridging element 41 from the stowed position into the functional position by means of the adjustment element 2. By using two coupling elements 424, the adjustment can be carried out in a safe and effective manner. When the bridging element 41 is in the stowed position, the coupling elements 424 are arranged at an angle of between 80° and 100° to the floor element 23 and the bridging element 41. The coupling elements 424 can be straight, i.e. have no curvatures. In the closed position, the bridging element 41 is arranged relative to the floor element 23 in such a way that its side used as a loading surface in the open position of the adjustment element 2 faces a side of the floor element 23 used as a loading surface in the open position of the adjustment element 2. During adjustment from the closed to the open position, the floor element 23 and the bridging element 41 pass through a point on the adjustment path at which they are arranged parallel to one another. In the closed position they form an angle of less than 20° to one another.

In the open position, the pivot element 33 can support the bridging element 41 and the floor element 23 together with its support arm 333 (not shown here).

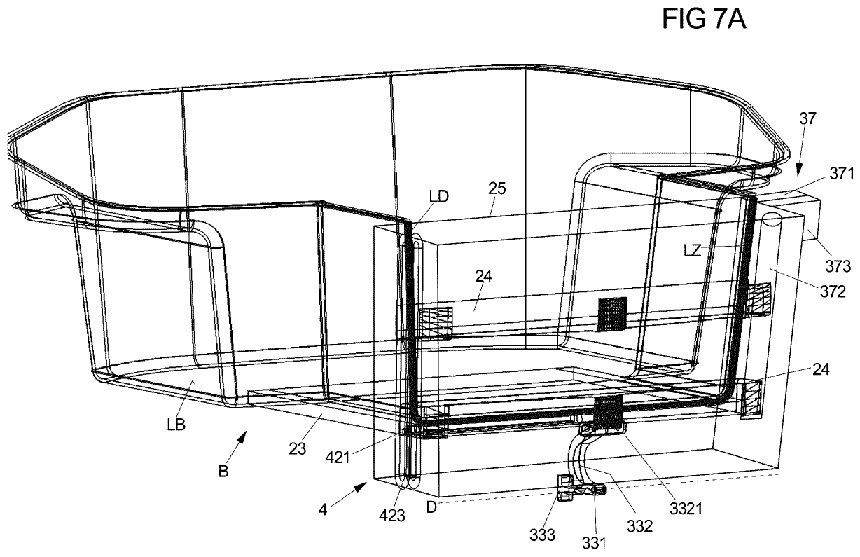

FIG. 7A and FIG. 7B show perspective views of a modular assembly B comprising a floor element 23 which, in a closed position of the adjustment element 2 in which the access opening LZ is closed, is arranged in a stowed position under the cargo space floor LB (FIG. 7A) and which, in an open position in which the access opening LZ is open, is provided for extending the cargo space floor LB (FIG. 7B). The adjustment element 2 comprises a trim element 25 and two carrier elements 24. The trim element 25 is adjustable between the closed and the open position via a pivot element 33. For this purpose, the pivot element 33 is designed as in the previous exemplary embodiments. In particular, the pivot element 33 has a support arm 333 via which the floor element 23 can be supported in the open position. Unlike the previous exemplary embodiments, the floor element 23 is not part of the adjustment element 2 and is not pivoted between the closed and the open position. Instead, the floor element 23 is coupled to the adjustment element 2 via an entrainment device 42, so that it is entrained during adjustment between the closed and the open position. While the adjustment of the adjustment element 2 is rotational, the floor element 23 is adjusted translationally. For this purpose, the entrainment device 42 has an entrainment lug 421 which is arranged on the floor element 23 and interacts with an associated guide element 423 in such a way that the floor element 23 is adjusted translationally when the adjustment element 2 is pivoted. The guide element 423 is kinematically coupled to the adjustment element 2. The trim element 25 of the adjustment element 2 is shell-shaped and at least partially accommodates the guide element 423, thereby improving the appearance of the modular assembly B.

In particular, the guide element 423 is designed in the manner of a slotted guide. A section of the guide element 423, which is arranged on the side of the cargo space L in the closed position of the adjustment element 2, presses against the entrainment lug 421 on the floor element 23 when the adjustment element 2 is adjusted to the open position. Conversely, a section of the guide element 423 which is arranged on the side facing away from the cargo space L in the closed position of the adjustment element 2 presses against the entrainment lug 421 on the floor element 23 when the adjustment element 2 is adjusted from the open position to the closed position. The guide element 423 is straight. A guide path for the entrainment lug 421 defined by the guide element 423 has no curvature.

The floor element 23 can be movably mounted on the cargo space L via a guide assembly, e.g. with a guide rail. The adjustment element 2 is positively guided here on the floor element 23 and the pivot element 33. In principle, it can be adjusted by adjusting the floor element 23 and/or by adjusting the pivot element 33.

In the embodiment shown, a linear drive 37 is provided which engages with the adjustment element 2 in order to adjust the adjustment element 2. For this purpose, the linear drive 37 is mounted on the side of the cargo space L, in particular hinged thereon. Specifically, the linear drive 37 is arranged on a section of the cargo space wall LW that is adjacent to the access opening LZ. To adjust the adjustment element 2 from the closed position to the open position, a telescopic arm 372 of the linear drive 37 is extended. The telescopic arm 372 is shown here only by way of example. A linear adjustment by an arm of the linear drive 37 can be achieved in a manner other than extending the telescopic arm 372 shown. This includes, for example, the adjustment of a spindle nut along an arm in the form of a spindle. The extension of the telescopic arm 372 causes a pivoting of the adjustment element 2 and a pivoting of the linear drive 37 in order to be able to follow the pivoting of the adjustment element 2. The linear drive 37 can, for example, be a spindle drive. In particular, the telescopic arm 372 in the closed position is perpendicular or at least at a small angle (for example, less than 10°) to a perpendicular to the cargo space floor LB. When the modular assembly B is used as intended in a motor vehicle K, safety can be increased in the event of a collision in the direction of travel. An adjusting force for adjusting the telescopic arm 372 is applied by a drive motor 371 which is coupled to the telescopic arm 372 via a gear assembly 373. Such a linear drive 37 can also be provided in the preceding exemplary embodiments in FIGS. 5A to 6B.

Alternatively, an adjustment drive can be provided which applies a rotational force to the adjustment element 2 to adjust it.

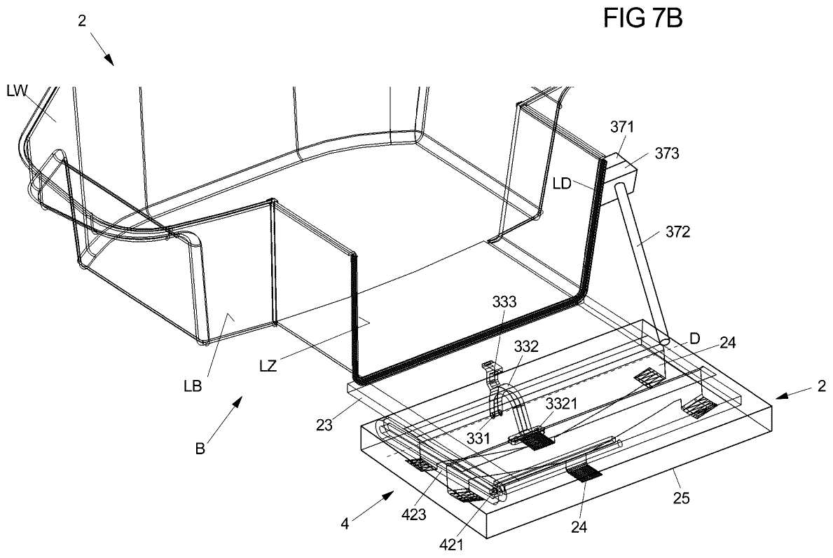

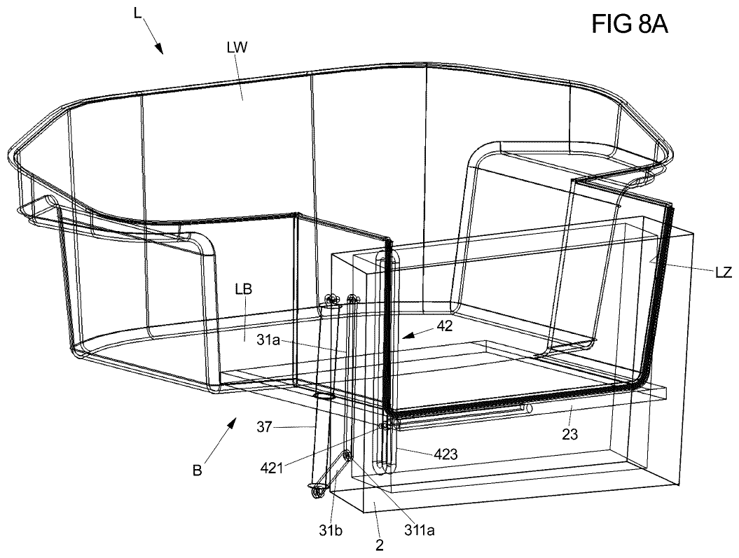

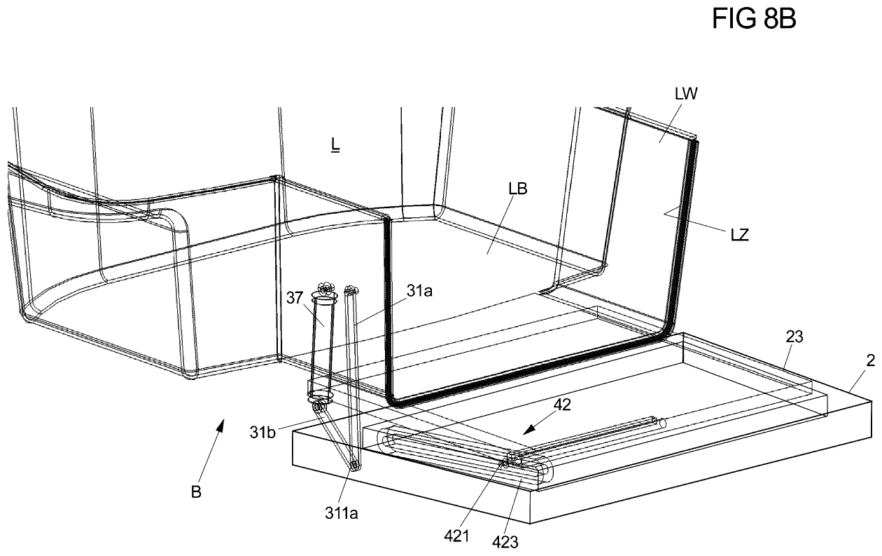

FIG. 8A and FIG. 8B show perspective views of a modular assembly B comprising an adjustment element 2, which is adjustable via a first and a second adjustment arm 31a, 31b. The first adjustment arm 31a is articulated with a first end at the cargo space L and with a second end at a mounting point 311a on the adjustment element 2. The second adjustment arm 31b is articulated at a first end to the mounting point 311a on the adjustment element 2 and can be actuated at a second end by a linear drive 37. The two adjustment arms 31a, 31b are rigid and straight.

The linear drive 37 is rigidly mounted on the cargo space L. With the linear drive 37, an adjustment of the second adjustment arm 31b can be predetermined along a straight line (purely translational adjustment). The straight line is arranged at an angle of less than 10°, in particular 0°, to a perpendicular to the cargo space floor LB. This can reduce the risk of injury to passengers caused by the linear drive 37 in the event of a collision. An adjusting force for adjusting the second adjustment arm 31b along a straight line is introduced into it at its second end. The second end is thereby shifted linearly. By linking the second adjustment arm 31b to the adjustment element 2, the linear displacement of the second end causes the second adjustment arm 31b to pivot about the mounting point 311a on the adjustment element 2. In addition, the adjustment element 2 is displaced translationally because the second adjustment arm 31b is rigid. In this way, an adjustment of the adjustment element 2 from the closed position (see FIG. 8A) to the open position (see FIG. 8B) can be achieved.

The modular assembly B further comprises a floor element 23, which in the closed position is stowed below the cargo space floor LB. In the open position, the floor element 23 forms an extension of the cargo space floor LB, so that objects can be more easily brought into the cargo space L by placing them on the floor element 23 before bringing them in. The floor element 23 can, for example, be guided on a guide rail arrangement on the cargo space L. For example, a guide rail can be arranged on each side of the floor element 23. A guide rail holder can be provided on the cargo space L side, on which the guide rails are each movably mounted. The floor element 23 can then be adjusted translationally along the guide rail holder.

The floor element 23 is coupled to the adjustment element 2 via an entrainment device 42. When the adjustment element 2 is adjusted between the closed and the open position, the floor element 23 is entrained by the entrainment device 42, that is to say, in particular when adjusted from the closed to the open position, it is adjusted from its stowed position into a functional position in which the floor element 23 extends the cargo space floor LB. A separate drive for adjusting the floor element 23 is therefore not absolutely necessary, but can be provided optionally.

The entrainment device 42 has a guide element 423 which is kinematically connected to the adjustment element 2. In addition, the entrainment device 42 has an entrainment lug 421 which is arranged on the floor element 23. The entrainment lug 421 is pin-shaped and engages in the guide element 423. The guide element 423 is designed in the manner of a slotted guide, within which the entrainment lug 421 is linearly movable. When adjusting the adjustment element 2 from the closed to the open position, the guide element 423 presses with a section that is arranged on the side of the cargo space L against the entrainment lug 421, so that the floor element 23 is pressed from the stowed position into its functional position. In addition, the design of the guide element 423 as a slotted guide allows the guide element 423 to pivot about the entrainment lug 421, so that the adjustment element 2 can pivot from the closed position to the open position and can entrain the floor element 23. When adjusting the adjustment element 2 from the open to the closed position, the guide element 423 presses against the entrainment lug 421 with a section which, in the closed position, is arranged on a side facing away from the cargo space L. This moves the floor element 23 from the functional position to the stowed position.

The adjustment element 2 is positively guided via the first adjustment arm 31a and the entrainment device 42 in such a way that the actuation of the adjustment element 2 by the second adjustment arm 31b causes the adjustment element 2 to be adjusted from the open to the closed position.

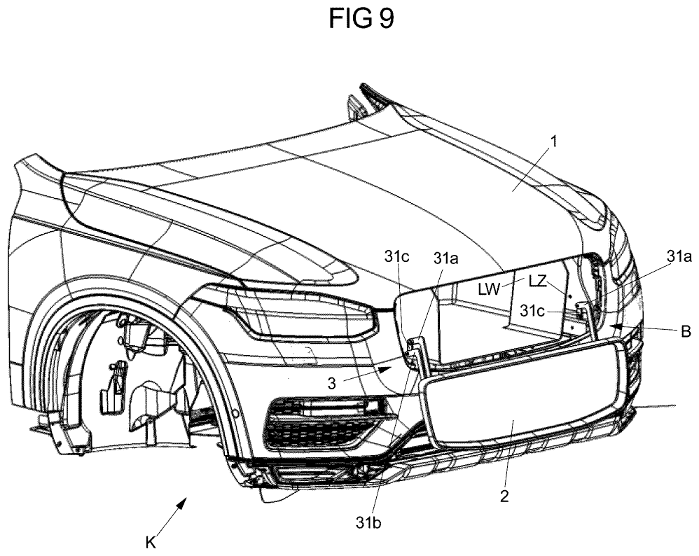

FIG. 9 shows a perspective view of a motor vehicle K comprising a modular assembly B, which has an adjustment element 2 which is adjustable via an adjustment device 3 with a plurality of adjustment arms 31a. The adjustment element 2 is shown in an open position in which it opens an access opening LZ to a cargo space L of the modular assembly B. A first and a second adjustment arm 31a, 31b are articulated on the side of the cargo space L and coupled to the adjustment element 2. The first and second adjustment arms 31a, 31b are angled. They each have an angle which, in the illustrated open position, is arranged such that it is aligned with an edge of a body section of the motor vehicle K in a plane transverse to the cargo space floor LB. The angle divides the adjustment arms 31a, 31b into a (short) first section on the side of the cargo space L and a (longer) second section on the side of the adjustment element 2.

The first and second adjustment arms 31a, 31b are hinged at their ends on the side of the cargo space L. The ends are connected via a third adjustment arm 31c. The third adjustment arm 31c is rigid. A distance between the articulation points of the first and second adjustment arms 31a, 31b on the side of the cargo space L is less than the length of the first and second adjustment arms 31a, 31b. The first and second adjustment arms 31a, 31b are arranged on a first side transverse to the direction of travel of the cargo space L. A further angled first adjustment arm 31a and a further third adjustment arm 31c are arranged on the second side. The adjustment element 2 can be further stabilized via the further first adjustment arm 31a. In principle, an identical arrangement of adjustment arms 31a, 31b, 31c or only one further first or second adjustment arm 31a, 31b can be provided on the two sides of the cargo space L transversely to the direction of travel to stabilize the adjustment element 2.

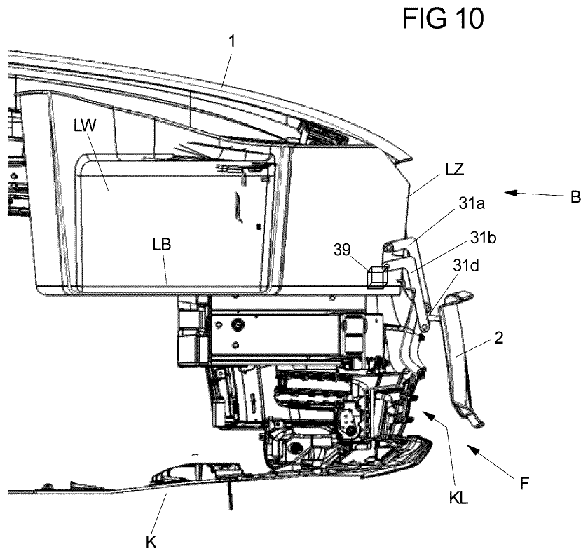

FIG. 10 shows a sectional view through the motor vehicle K of FIG. 9. It can be seen that the ends of the first and second adjustment arms 31a, 31b facing the adjustment element 2 can be connected to one another via a fourth adjustment arm 31d. The adjustment device 3 can therefore be designed in the manner of a four-bar linkage. The third and/or fourth adjustment arms 31c, 31d can each have a tongue, as shown here, by means of which they are fastened on the side of the cargo space (third adjustment arm 31c) and/or on the side of the adjustment element 2 (fourth adjustment arm 31d).

In the illustrated open position of the adjustment element 2, the adjustment element 2 is arranged along the direction of travel of the motor vehicle K in front of a front section F of the motor vehicle K. The adjustment element 2 is offset parallel to its position in the closed position. An advantage of the arrangement of the adjustment element 2 on the cargo space L via the at least two adjustment arms 31a, 31b is that the adjustment element 2 in the open position does not block an air intake system KL because it is at a distance from it in the direction of travel, so that air can penetrate into the air intake system KL unhindered.

With such a configuration of adjustment arms 31a, 31b, 31c, 31d, the adjustment element 2 can be adjusted in parallel between the open and the closed position. In particular, it is not necessary for the adjustment element 2 to be rotated in the open position relative to the closed position. A user can thus approach closer to the access opening LZ in order to store objects in the cargo space L than is the case with an adjustment element 2, which is rotated from the closed to the open position in a region in front of the access opening LZ.

Furthermore, in this exemplary embodiment it is not absolutely necessary for the hood element 1 to be opened in order to be able to adjust the adjustment element 2. The adjustment element 2 can thus be adjusted independently of the hood element 1. This may in particular make it possible to separate a section of the cargo space L accessible via the access opening LZ from a section of the cargo space L accessible via the loading opening LO. An adjusting force required for the adjustment can be provided, for example, by an adjustment drive 39 which acts on one of the adjustment arms 31a, 31b.

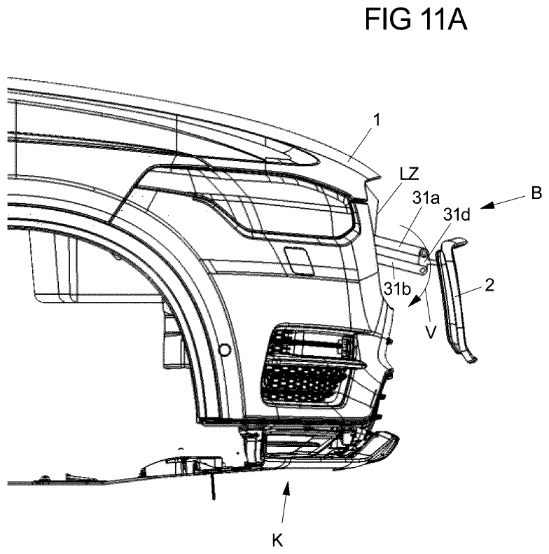

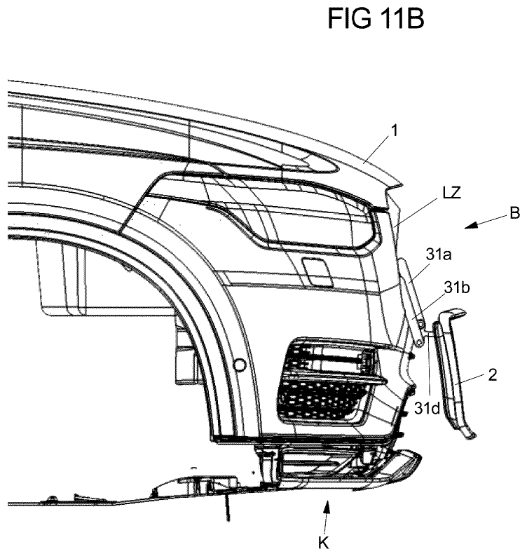

FIG. 11A and FIG. 11B show views of the adjustment element 2 during adjustment from the closed position to the open position. FIG. 11A shows the adjustment element 2 on an adjustment path V in the open position. In FIG. 11B, the adjustment element 2 is arranged in the open position. The adjustment via the adjustment arms 31a, 31b causes the adjustment element 2 to move further along the direction of travel of the motor vehicle K in front of the access opening LZ during an adjustment movement along the adjustment path V than is the case in the open position. In the open position, the adjustment element 2 is arranged below a level defined by the cargo space floor LB. This is made possible by the fact that the adjustment arms 31a, 31b are designed and arranged such that in the open position they are angled downward away from the cargo space L.

FIG. 12 shows a perspective view of a motor vehicle K comprising an adjustment element 2 which is adjustably mounted relative to the cargo space L via two adjustment arms 31a, 31b which are arranged in such a way that they are angled upward away from the cargo space L in the open position of the adjustment element 2. The angle between the first and the second section of the adjustment arms 31a, 31b is designed such that the adjustment arms 31a, 31b extend around a front edge of the hood element 1 of the motor vehicle K in the direction of travel in the open position. As a result, the adjustment element 2 can be arranged in the open position at a greater distance from the access opening LZ than if the adjustment arms 31a, 31b are straight. As in the previous exemplary embodiment, the adjustment arms 31a, 31b each comprise a first section and a second section, which is spaced further apart from the cargo space L than is the first section and is longer than the first section.

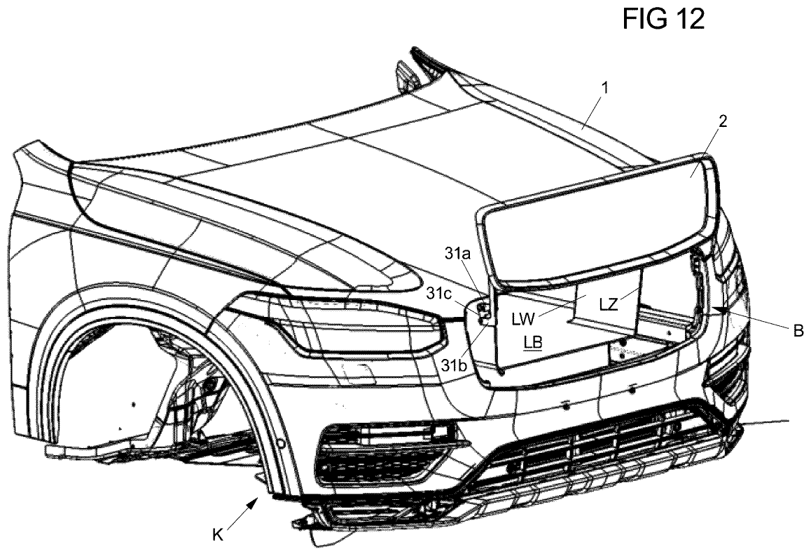

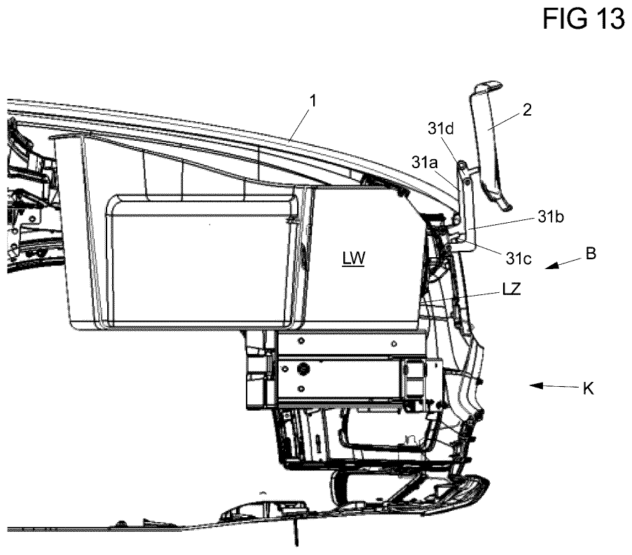

FIG. 13 shows a sectional view through the motor vehicle K shown in FIG. 12. A fourth adjustment arm 31d is visible via which the first and second adjustment arms 31a, 31b are coupled on the side of the adjustment element 2.

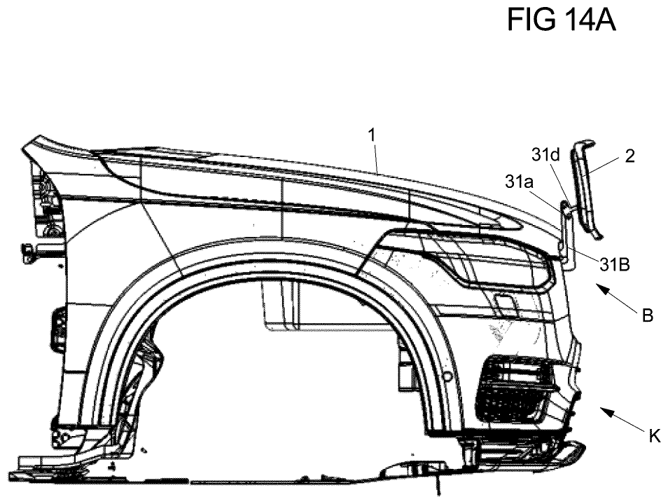

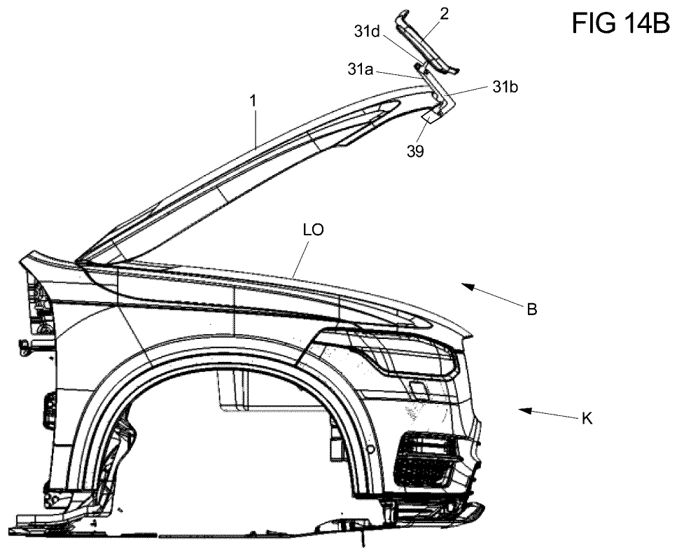

FIG. 14A and FIG. 14B show views of a motor vehicle K comprising a hood element 1 for closing a cargo space opening and an adjustment element 2 which is kinematically connected to the hood element 1. The adjustment device 3 can in principle be kinematically connected to the cargo space L or to the hood element 1. A kinematic connection with the hood element 1 has the advantage that the access opening LZ is opened together with the loading opening LO when the hood element 1 is adjusted. An adjustment of the adjustment element 2 relative to the hood element 1 is not necessary here, because the adjustment of the hood element 1 already ensures that the access opening LZ is opened. If, as in the present exemplary embodiment, an adjustment device 3 is provided for adjusting the adjustment element 2, this can be used to open the access opening LZ separately from the opening of the loading opening LO. This is shown in FIG. 14A. In addition, the adjustment device 3 can be used to adjust the adjustment element 2 from an access region to the loading opening LO when the hood element 1 is in the open position. This is shown in FIG. 14B. This makes it possible—in the case of an adjustment element 2 that is kinematically connected to the hood element 1—to prevent a user from hitting the adjustment element 2 with his head, for example, when the hood element 1 is in the open position. The adjustment of the adjustment element 2 can be carried out via an adjustment drive 39. The adjustment of the hood element 1 and of the adjustment element 2 can be carried out independently of one another or coordinated with one another, for example by an electronic control unit S.

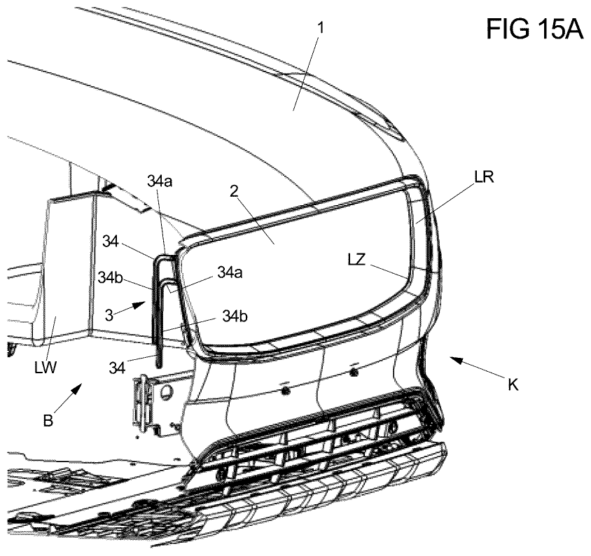

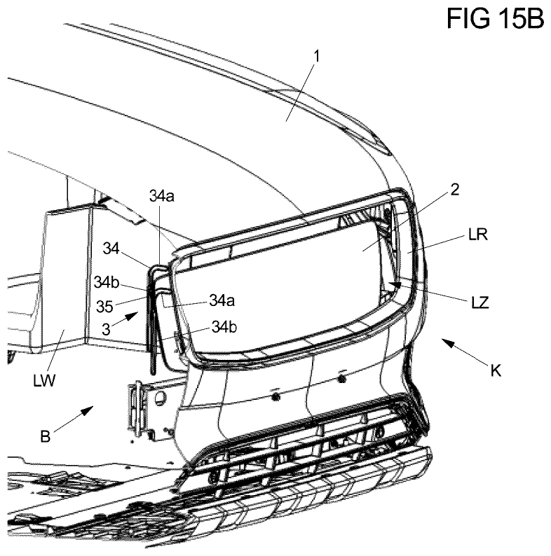

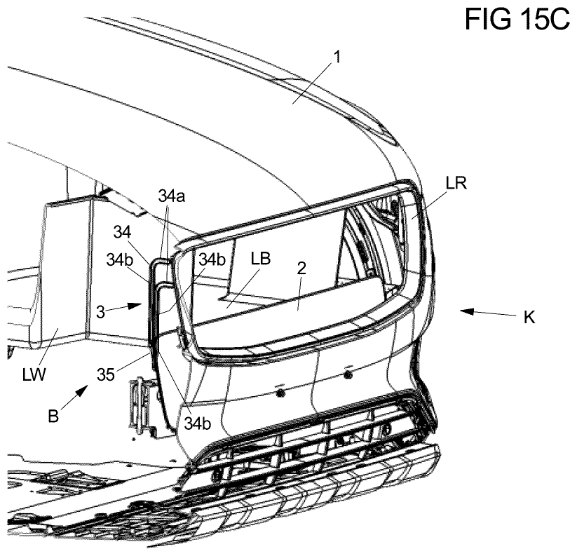

FIGS. 15A to 15C show perspective views of a motor vehicle K comprising an adjustment element 2, which is adjustable via an adjustment device 3 with two sliding guides 34. The access opening LZ is framed here by a frame element LR, on which the adjustment element 2 is arranged in the closed position (see FIG. 15A).

When adjusting from the closed position to an open position, in which the adjustment element 2 opens the access opening LZ, the adjustment element 2 is adjusted along the two sliding guides 34. For mounting the adjustment element 2 on the sliding guides 34, the adjustment device 3 has two sliders 35 which are arranged on the adjustment element 2. The sliders 35 are guided on the sliding guides 34 in the manner of a slotted guide. Each of the sliders 35 is assigned to one of the sliding guides 34.

The sliding guides 34 have a first section 34a, which is arranged at an angle between 80° and 100°, in particular 90°, to the access opening LZ. In particular, the first section 34a of the sliding guides 34 is arranged parallel to the cargo space floor LB. During the adjustment of the adjustment element 2 along the first section 34a of the sliding guides 34, the adjustment element 2 is therefore displaced parallel from the frame element LR in the direction of the cargo space L. The sliding guides 34 have a second section 34b, which is arranged at an angle of less than 20° to the access opening LZ. In particular, the second section of the sliding guides 34 is arranged perpendicular to the cargo space floor LB. During the adjustment of the adjustment element 2 along the second section 34b of the sliding guides 34, the adjustment element 2 is therefore adjusted by the frame element LR in a direction toward the cargo space floor LB and beyond. The first section 34a of the sliding guides 34 is shorter than the second section 34b of the sliding guides 34. The sections of the sliding guides 34 are arranged at right angles to each other such that each of the sliding guides 34 is L-shaped.

The first and second sections 34a, 34b of the sliding guides 34 are connected to one another via a curved section. In the adjustment position shown in FIG. 15B, the adjustment element 2 is arranged between the curved section and the second section 34b of the sliding guides 34. In the adjustment position shown in FIG. 15C, the adjustment element 2 is arranged in the open position. In the open position, the adjustment element 2 between the cargo space floor LB and the frame element LR is at least partially sunk below a plane defined by the cargo space floor LB.

The two sliding guides 34 are arranged offset from one another. Both sliding guides 34 are located in a plane perpendicular to the cargo space floor LB. The first sections 34a of the sliding guides 34 are spaced at a distance from one another (along a line perpendicular to the cargo space floor LB), while the second sections 34b of the sliding guides 34 abut one another. In principle, the second sections 34b of the sliding guides 34 can also be arranged spaced at a distance from one another.

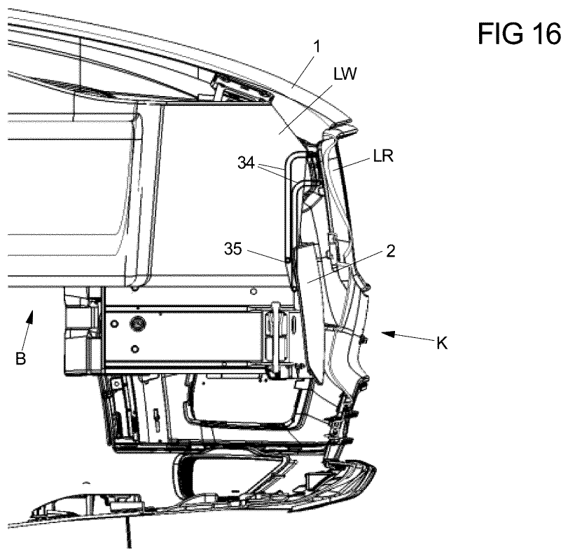

FIG. 16 shows a sectional view through the motor vehicle K in FIG. 15C. It is particularly clearly visible that the adjustment element 2 is adjustably mounted on the two sliding guides 34 via a single slider 35. The slider 35 is in engagement with both sliding guides 34. It is rigid and straight. It is oriented at an angle to the cargo space floor LB. This allows an adjustment of the adjustment element 2 into a closed position, which closes an access opening LZ arranged at an angle other than 90° to the cargo space floor LB.

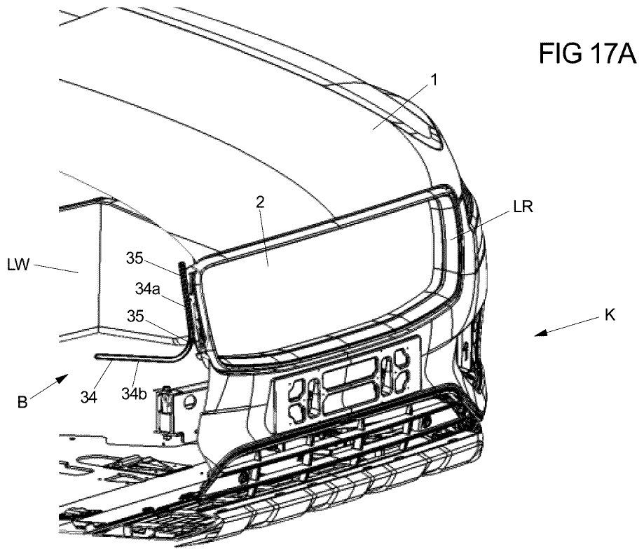

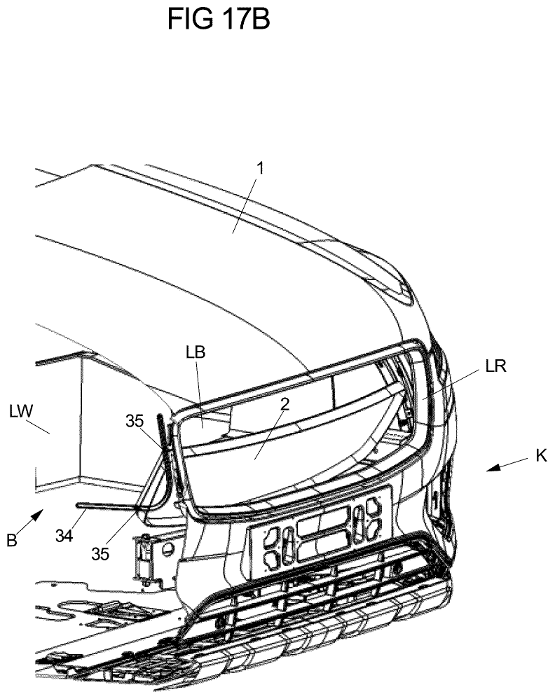

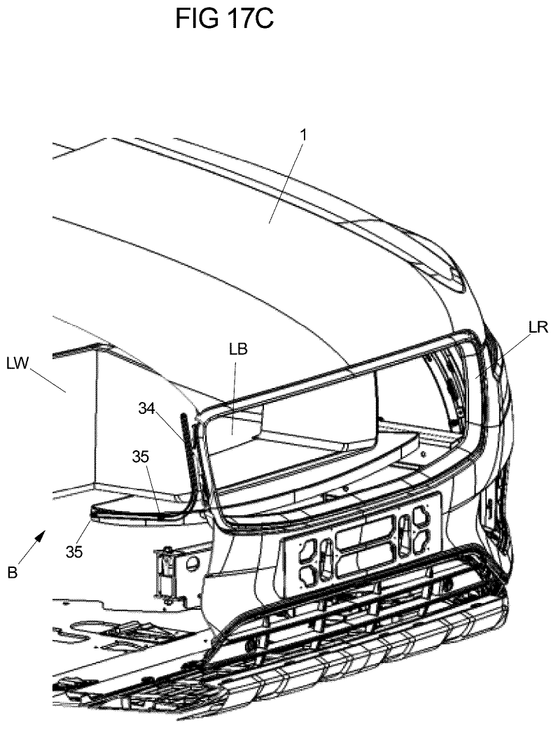

FIGS. 17A to 17C and FIG. 18 show an alternative embodiment of the adjustment device 3 of the previous exemplary embodiment. Here, the adjustment device 3 comprises one instead of two sliding guides 34. The adjustment element 2 is adjustably mounted on one sliding guide 34 via two sliders 35. The sliding guide 34 has a first section 34a which extends parallel to the access opening LZ. The adjustment element 2 is mounted on the first section 34a of the sliding guide 34 when it is in the closed position (see FIG. 17A and its associated sectional view in FIG. 18). Furthermore, the sliding guide 34 has a second section 34b which is arranged obliquely to the access opening LZ, in particular at an angle of 90° thereto. The adjustment element 2 is arranged in the open position on the second section 34b of the sliding guide 34 (see FIG. 17C).

During the adjustment from the closed to the open position, the adjustment element 2 rotates about an axis of rotation D perpendicular to the sliding guide 34 (see FIG. 17B). A rotation angle about which the adjustment element 2 rotates corresponds to an angle between the first and the second section 34a, 34b of the sliding guide 34. The rotation is made possible by the two sliders 35 arranged spaced apart from one another. In principle, such a rotation can also be caused by a single slider 35. For this purpose, its length can be greater than a height (perpendicular to the adjustment direction) of a link of the link guide, which is provided by the sliding guide 34. The slider 35 is received in the link, so that the slider 35 is rotated by the link guide during the transition from the first section 34a to the second section 34b of the sliding guide 34.

In the open position, a rear side of the adjustment element 2, which in the closed position faces the cargo space L, can serve as a bridging element between the access opening LZ and the cargo space floor LB, so that objects for storage in the cargo space L can first be placed on the adjustment element 2.

FIGS. 15A to 18 each show an adjustment device 3 comprising one or two sliding guides 34. The figures show the at least one sliding guide 34 only on one side of the adjustment element 2. In principle, the adjustment element 2 can also be guided in a sliding manner via one or two further sliding guides 34 on its other side (transverse to the direction of travel). An adjusting force for adjusting the adjustment element can be applied to the adjustment element for example, via a flexible traction means from a traction means drive.

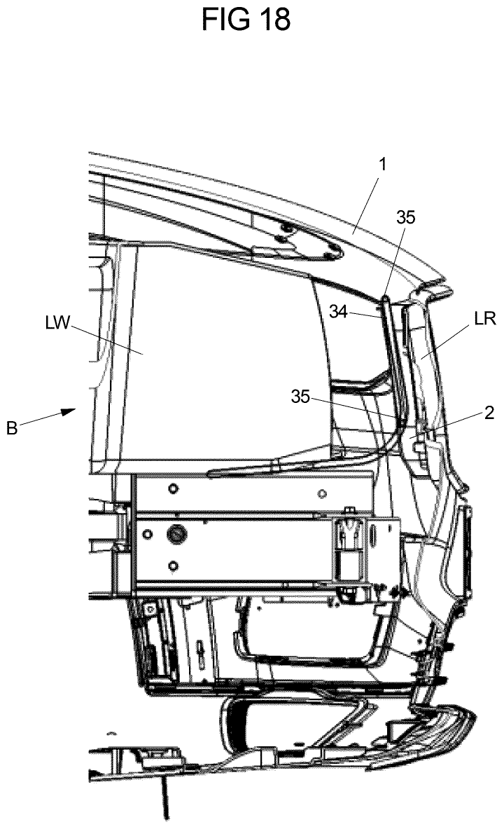

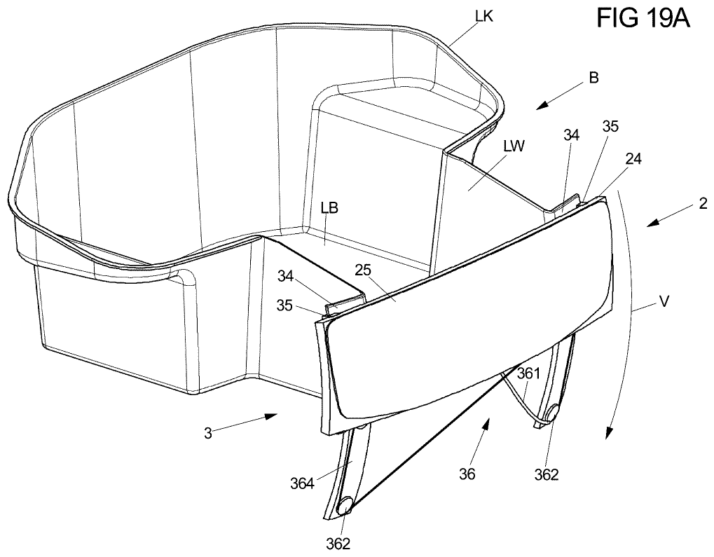

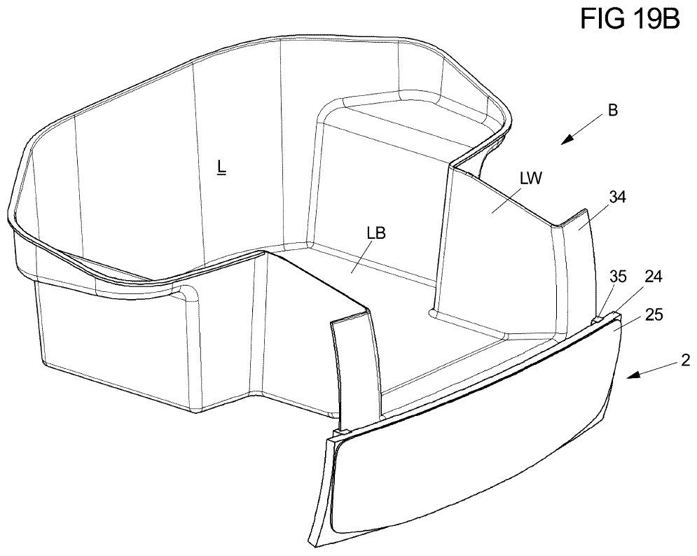

The exemplary embodiments in FIGS. 19A to 21 show a further exemplary embodiment in which the adjustment element 2 is adjustable via an adjustment device 3 with a sliding guide 34. In this exemplary embodiment, two sliding guides 34 are provided, by means of which the adjustment element 2 is held relative to the cargo space L. In principle, a sliding guide 34 is sufficient for safely adjusting the adjustment element 2.

The sliding guides 34 are formed in one piece with the cargo space wall LW. Specifically, the sliding guides 34 at the access opening LZ project from the cargo space wall LW outward, away from the access opening LZ. They form a right angle with the adjacent section of the cargo space wall LW. A first sliding guide 34 projects outward from a first side of the access opening LZ and a second sliding guide 34 projects outward from a second side of the access opening LZ opposite the first side. The two sliding guides 34 project in particular in opposite directions from the cargo space wall LW. The length of the sliding guides 34 corresponds to more than 50% of the height of the cargo space wall LW. At the access opening LZ, the height of the cargo space wall LW is identical to the height of the sliding guides 34. The sliding guides 34 are thus extended along the height of the access opening LZ above the cargo space floor LB. In addition, the sliding guides 34 project from the cargo space floor LB in a direction away from the cargo space L (downward). The sliding guides 34 have a slight curvature with a radius of curvature of more than 1 m. The adjustment element 2 is therefore mounted so as to be displaceable along a curved adjustment path V along the sliding guides 34.

Provided on the adjustment element 2 are sliders 35 into each of which the sliding guides 34 engage (the sliding guides 34 can also be designed such that the sliders 35 engage in them). In cross-section, the sliders 35 are U-shaped. Each slider 35 comprises an edge of the relevant sliding guide 34 pointing outward from the access opening LZ. Because the sliders 35 have a length of more than 50% of a height of the cargo space wall LW, the adjustment element 2 is securely mounted on the cargo space wall LW. In particular, the sliders 35 have at least a length corresponding to a height of the access opening LZ above the cargo space floor LB. In this case, the sliders 35 are as long as the sliding guides 34.

The adjustment element 2 is adjustable via a flexible traction means 361 between a closed position in which the adjustment element 2 closes the access opening LZ (see FIG. 19A), and an open position in which the adjustment element 2 opens the access opening LZ (see FIG. 19B). The traction means 361 is designed such that it can be actuated in a first direction to move the adjustment element 2 from the closed to the open position, and can be actuated in a second direction, which is opposite the first direction, to move the adjustment element 2 from the open to the closed position. For this purpose, the flexible traction means 361 is deflected at a plurality of deflection elements 362.

FIG. 20 shows a perspective view of the modular assembly B, in which the adjustment assembly 36 for adjusting the adjustment element 2 is shown. The flexible traction means 361 is deflected at a plurality of points via deflection elements 362, which are arranged on two traction means guides 364. Two deflection elements 362 are arranged at a distance apart from one another on the traction means guides 364. Between the deflection elements 362, the flexible traction means 361 extends parallel to the traction means guides 364. On the section of the flexible traction means entrainment lug 361 which extends parallel to the traction means guides 364, a traction means entrainment lug 363 is provided (possibly in each case), on which the adjustment element 2 is mounted. When the flexible traction means entrainment lug 361 is adjusted, the adjustment element 2 is thus entrained via the traction means entrainment lug 363. The traction means guides 364 are arranged below the cargo space floor LB so that they are not visible from the outside. Rail elements (for example made of metal) are suitable as traction means guides 364. The traction means entrainment lug 363 can be guided on the traction means guides 364. The traction means guides 364 are kinematically connected to the cargo space L.

The flexible traction means 361 is deflected by the deflection elements 362, which are each arranged on one of the traction means guides 364 on the side of the cargo space L, to the deflection elements 362 of the other traction means guide 364, which are each further spaced apart from the cargo space L. As a result, the flexible traction means 361 crosses itself between the traction means guides 364.

A traction means drive 365 is provided to drive the flexible traction means 361. In principle, this can drive the flexible traction device 361 at any location. In the present case, the traction means drive 365 is arranged between the traction means guides 364 in an adjustment plane of the adjustment element 2. During adjustment of the adjustment element 2 between the closed and the open position, the traction means 361 is adjusted by a length that corresponds at most to the distance between two deflection elements 362 on the traction means guide 364.

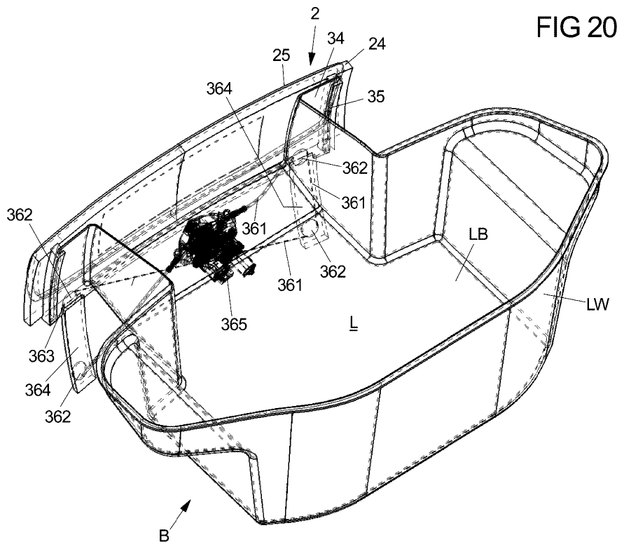

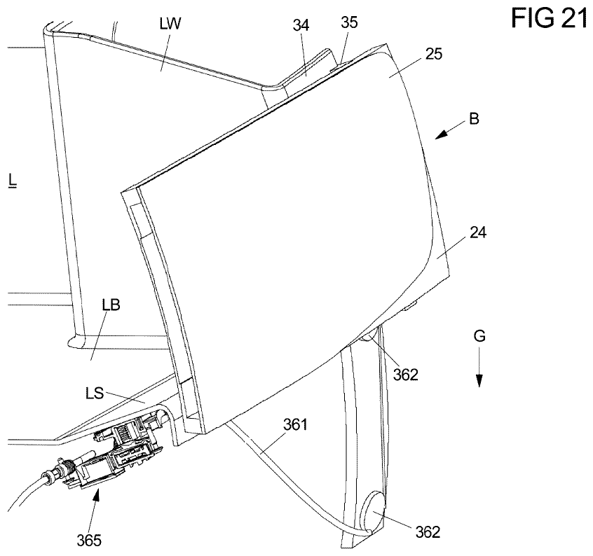

FIG. 21 shows a sectional view through the modular assembly B in FIG. 19A. The adjustment element 2 here comprises a carrier element 24 and a trim element 25 which is arranged on the carrier element 24. As a result, the adjustment element 2 is designed as a double shell. A space is provided between the carrier element 24 and the trim element 25. The space can be used, for example, to arrange a logo or to arrange a display. The trim element 25 can be transparent, for example made of glass or transparent plastic. In addition, the trim element 25 and/or the carrier element 24 is curved outward away from the access opening LZ in the manner of a side window of a motor vehicle K, although this is optional. Such a design of the adjustment element 2, in particular with the space, can be provided in all embodiments described in the present disclosure.

Furthermore, the cargo space floor LB is extended by a threshold element LS, which has a loading surface arranged at an angle to the cargo space floor LB. The slope of the threshold element LS is designed in such a way that an object placed on the loading surface of the threshold element LS slides onto the cargo space floor LB due to the earth's gravity line G. In addition, the threshold element LS serves to create a level termination of the loading surface with an upper edge of the adjustment element 2 in the open position. The threshold element LS is also angled outward away from the cargo space L (downward) in order to conceal a region below the cargo space L. In addition, the threshold element LS allows sealing of the cargo space L with the adjustment element 2 in the closed position. Such a threshold element LS can be provided in all embodiments described in the present disclosure.

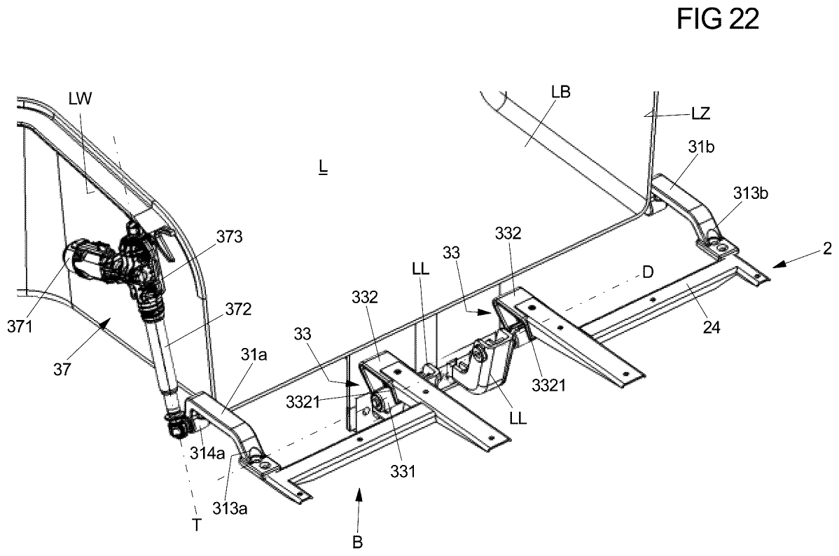

FIGS. 22 to 28C show views of an exemplary embodiment in which the adjustment element 2 is pivotally mounted about an axis of rotation D relative to the cargo space L, wherein the mounting is eccentric to the axis of rotation D and wherein an adjustment arm 31a is provided on the adjustment element 2, which arm can be actuated via a linear drive 37 to pivot the adjustment element 2. A further adjustment arm 31b is optionally available and can be actuated via a further linear drive to pivot the adjustment element 2. Thus, the adjustment element 2 can optionally be adjusted by two linear drives 37 simultaneously. The linear drive(s) 37 can be controlled (and thus also coordinated) by an electronic control unit S.

FIG. 22 shows a perspective view of a modular assembly B in which the adjustment element 2 is mounted on an axis of rotation D via two pivot elements 33. The adjustment element 2 is mounted at a distance from the axis of rotation D via the pivot elements 33. In principle, the adjustment element 2 can alternatively be mounted on the axis of rotation D directly or via one or more pivot elements 33. The adjustment element 2 in this case comprises a carrier element 24 to which, for example, a trim element 25 and/or a floor element 23 can be attached. The carrier element 24 comprises, by way of example, a first section arranged on a first of the pivot elements 33 and a second section arranged on a second of the pivot elements 33. The first and second sections of the carrier element 24 are separated from one another so that they can be adjusted independently of one another. For example, it is conceivable and possible for the first section of the carrier element 24 to close a first section of the access opening LZ and for a second section of the access opening LZ, which can be closed with the second section of the carrier element 24, to be open. This makes it possible, for example, to quickly store small objects in the cargo space L.

Two adjustment arms 31a, 31b engage the adjustment element 2. One of the adjustment arms 31a can be actuated by a linear drive 37. The linear drive 37 is designed and provided to perform a linear adjustment movement in order to adjust the adjustment arm 31a. The linear drive 37 is pivotally mounted on the cargo space L, so that the actuation of the adjustment arm 31a leads to a pivoting of the linear drive 37 and the adjustment arm 31a is thus adjusted on a circular path about the axis of rotation D. This allows the adjustment element 2 to be adjusted between the open and closed positions.

The pivot elements 33 are each pivotally mounted on a mounting element LL relative to the cargo space L. The mounting elements LL provide a common axis of rotation D about which the adjustment element 2 can be pivoted via the pivot elements 33. In principle, one, two or more pivot elements 33 can be provided for pivoting the adjustment element 2. The pivot elements 33 each have a mounting section 331 via which they are arranged on the mounting elements LL. The mounting section 331 is arranged offset from the mounting element LL along the axis of rotation D. The mounting elements LL for the two pivot elements 33 are arranged axially inward, while the pivot elements 33 are arranged axially outward.

The adjustment element 2 is arranged on a connecting arm 332 of the pivot elements 33. The connecting arm 332 has a connecting section 3321 for this purpose. The connecting arm 332 is angled. In cross-section to the axis of rotation D, the connecting arm 332 has a wedge shape. The angle at which the connecting arm 332 is curved is an acute angle. A section of the connecting arm 332 adjacent to the connecting section 3321 forms a flat support which, in the illustrated open position of the adjustment element 2, can be used to support a floor element 23, so that even heavy objects can be placed thereon without the floor element 23 being deformed or broken.

The adjustment arms 31a, 31b each have an engagement section 313a, 313b via which they engage the adjustment element 2, in particular its carrier element 24. In addition, the adjustment arms 31a, 31b each have an actuating section 314a, 314b via which they can be actuated by a linear drive 37. Such a linear drive 37 is provided for actuation on a first of the two adjustment arms 31a. A linear drive 37 can also be provided on the second of the adjustment arms 31b. Alternatively, the actuating section 314b of the second adjustment arm 31b can be used to arrange a flexible stop element 38. The second adjustment arm 31b is provided optionally and can be used, for example, in the exemplary carrier element 24 with two sections for the separate actuation of one of the sections.

Between the engagement section 313a, 313b and the actuating section 314a, 314b, a straight section of the adjustment arm 31a, 31b is extended which in the open position is formed parallel to the cargo space floor LB. The adjustment arms 31a, 31b are therefore bridge-shaped. The straight section is oriented transversely to the axis of rotation D. By designing the adjustment arms 31a in this way, the appearance of the modular assembly B in the open position and safety during use of the modular assembly B can be improved.

The linear drive 37 has a drive motor 371 which is connected to a telescopic arm 372 via a gear assembly 373. The linear drive 37 is arranged as a whole pivotally on a section of the cargo space wall LW which extends transversely to the axis of rotation D. Actuation of the drive motor 371 causes the generation of a driving force which is introduced into the telescopic arm 372 via the gear assembly 373. The telescopic arm 372 is thereby extended linearly. In principle, the telescopic arm 372 can have any shape that allows a linear adjustment of the actuating section 314a, 314b of the associated adjustment arm 31a, 31b. For example, the telescopic arm 372 may have a spindle which, by rotation, linearly adjusts a spindle nut on which the actuating section 314a, 314b is arranged.

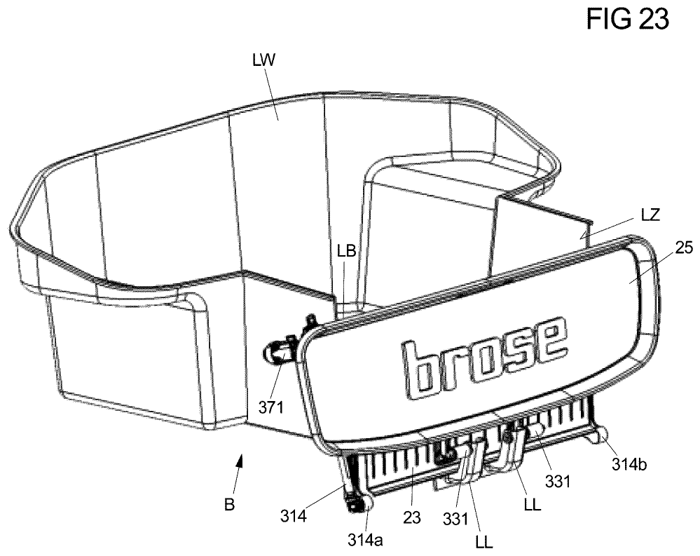

FIG. 23 shows a perspective view of the modular assembly B with the adjustment element 2 in the closed position. In addition, a trim element 25 is arranged on the adjustment element 2 which conceals the carrier element 24 from the outside in the closed position. The adjustment element 2 comprises a floor element 23, which closes the access opening LZ in the closed position. The floor element 23 projects beyond the access opening LZ into a region below the cargo space floor LB which is facing away from the cargo space L. In the open position, it can dock directly to the cargo space floor LB and thus extend it, so that the insertion of objects into the cargo space L is made easier by the fact that they can first be placed on the floor element 23. Alternative embodiments of the floor element 23, such as the additional use of a bridging assembly 4 as described in the present disclosure, are also conceivable and possible.

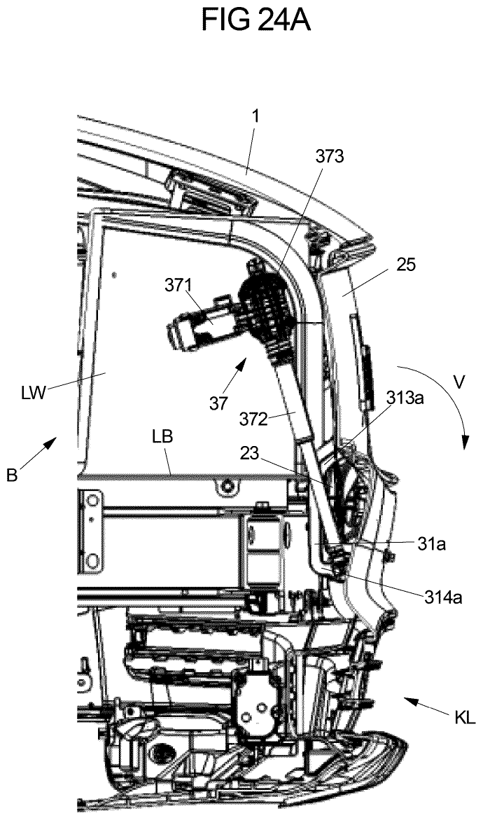

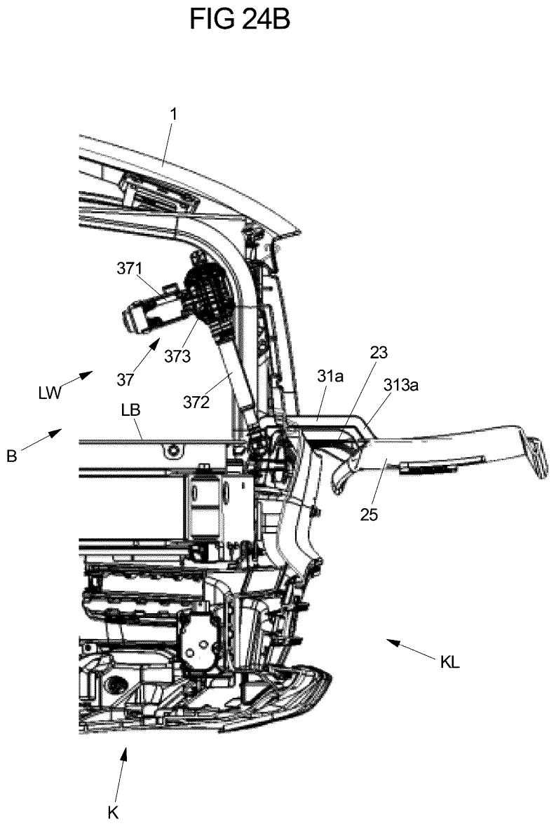

FIGS. 24A and 24B show sectional views through a motor vehicle K comprising a modular assembly B with a linear drive 37. In the closed position of the adjustment element 2, which is shown in FIG. 24A, the adjustment arm 31a is arranged at least over 50% of its length below a plane which is defined by the cargo space floor LB. The telescopic arm 372 of the linear drive 37 is fully extended in this closed position of the adjustment element 2. The adjustment element 2 can be locked to the hood element 1 here as in all other exemplary embodiments. An air intake system KL is provided below the modular assembly B in the motor vehicle K. This allows air to be drawn in regardless of the position of the adjustment element 2.

In the open position of the adjustment element 2, which is shown in FIG. 24B, the adjustment arm 31a is arranged at least over 50%, in particular over 90%, of its length above a plane which is defined by the cargo space floor LB. The telescopic arm 372 of the linear drive 37 is fully retracted in this open position of the adjustment element 2. The linear drive 37 is pivoted toward the adjustment element 2 relative to the closed position. An angle between the adjustment arm 31a in the closed position and the adjustment arm 31a in the open position is 90°. The adjustment element 2 is adjustable by adjusting the adjustment arm 31a along an adjustment path V about the axis of rotation D, which track corresponds to a circular segment of 80° to 100°, in particular 90°. In principle, any desired length of the adjustment path V can be chosen.

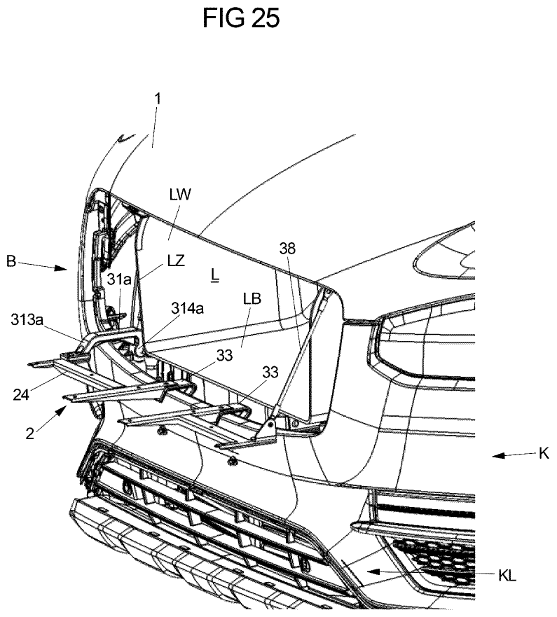

FIG. 25 shows a perspective view of a motor vehicle K with a modular assembly B and an adjustment element 2 in the open position. In this exemplary embodiment, only one adjustment arm 31a is provided and can be actuated via a linear drive 37. The adjustment arm 31a is arranged on one side of the cargo space L (adjacent to a cargo space wall LW on a side facing away from the cargo space L). A flexible stop element 38 is provided on the other side of the cargo space L. The flexible stop element 38 is provided with one end on the cargo space L, in particular on a section of a cargo space wall LW which is adjacent to the access opening LZ. The other end of the flexible stop element 38 is attached to the adjustment element 2, in particular its carrier element 24. In the illustrated open position of the adjustment element 2, the flexible stop element 38 is tensioned. The adjustment element 2 can therefore not move from the closed position beyond the open position. This means that the adjustment element 2 can be used safely even if heavy objects are placed on it. Such a flexible stop element 38 can in principle be used with any adjustment element 2 which is available in the open position for extending the cargo space floor LB. In particular, it can be provided in all embodiments in which the adjustment element 2 (or a floor element 23 guided thereon) can be used in the open position to extend the cargo space floor LB. This applies in particular to embodiments in which the adjustment element 2 is mounted eccentrically so as to be pivotable about an axis of rotation D. In principle, the stop element 38 can alternatively be designed to be rigid.

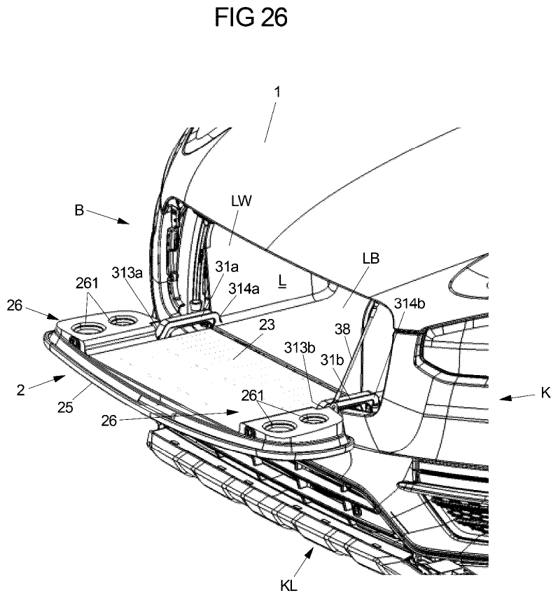

FIG. 26 shows a modification of the exemplary embodiment in FIG. 25, in which a second adjustment arm 31a is provided as an example. In addition, a holding device 26 is provided on the adjustment element 2, which can be used to secure an object stored on the adjustment element 2 against unintentional displacement on the loading surface. Specifically, the illustrated holding device 26 is designed to hold a (cylindrical) object such as a drinking cup. For this purpose, the holding device 26 has at least one recess into which the object can be inserted. In the present case, four recesses 261 are provided, two on each side of the adjustment element 2 (viewed along the axis of rotation D). The holding device 26 is arranged in a region which, in the closed position, lies outside the access opening LZ (along the axis of rotation, laterally next to the access opening LZ), so that the access opening LZ can be securely closed by the floor element 23. In the open position, the floor element 23 serves to extend the cargo space floor LB in the direction of travel of the motor vehicle K.

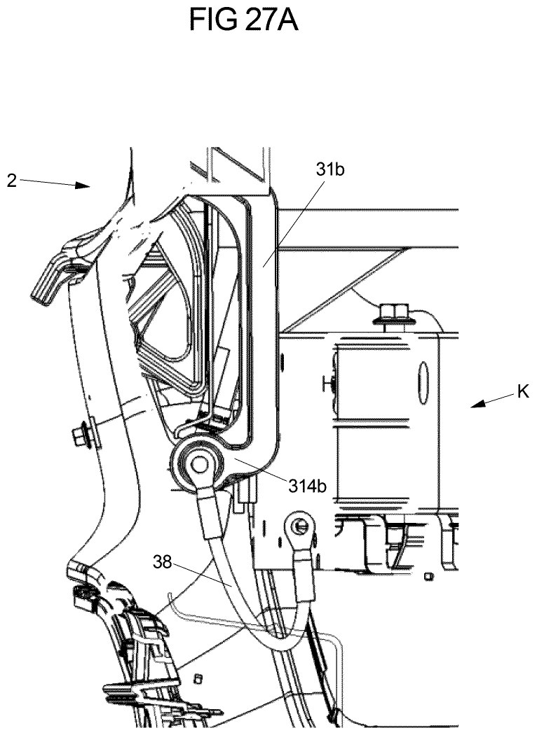

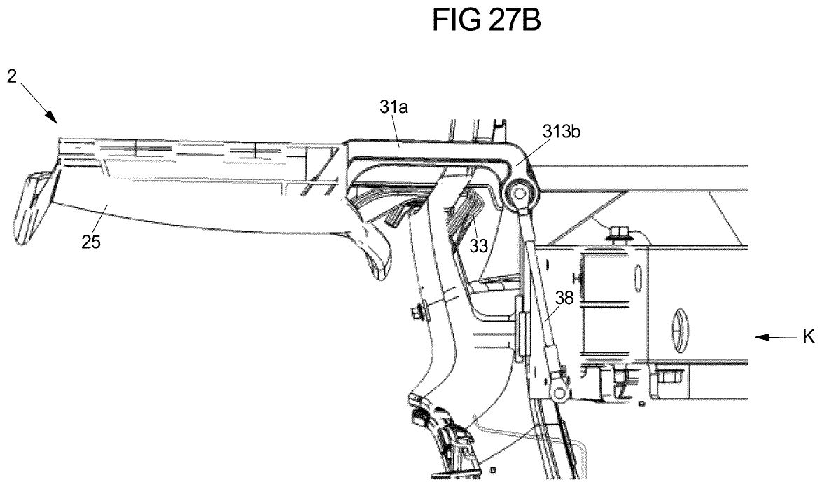

FIGS. 27A and 27B show sectional views through the motor vehicle K in the form of a detailed view of the second adjustment arm 31b. Here, a flexible stop element 38 is arranged on the actuating section 314b of the second adjustment arm 31b, which flexibly connects the actuating section 314b to a body structure of the motor vehicle K or the cargo space L of the modular assembly B. In the closed position (see FIG. 27A), the flexible stop element 38 is loose. In the open position (see FIG. 27B), the flexible stop element 38 is tensioned so that it limits an adjustment movement of the adjustment arm 31b in the direction of the open position. This allows the adjustment element 2 to be secured against unintentional adjustment beyond the open position. In addition to the flexible stop element 38 which acts directly on the adjustment element 2, the flexible stop element 38 can be provided as a further flexible (or alternatively rigid) stop element 38 (see FIGS. 25 and 26).

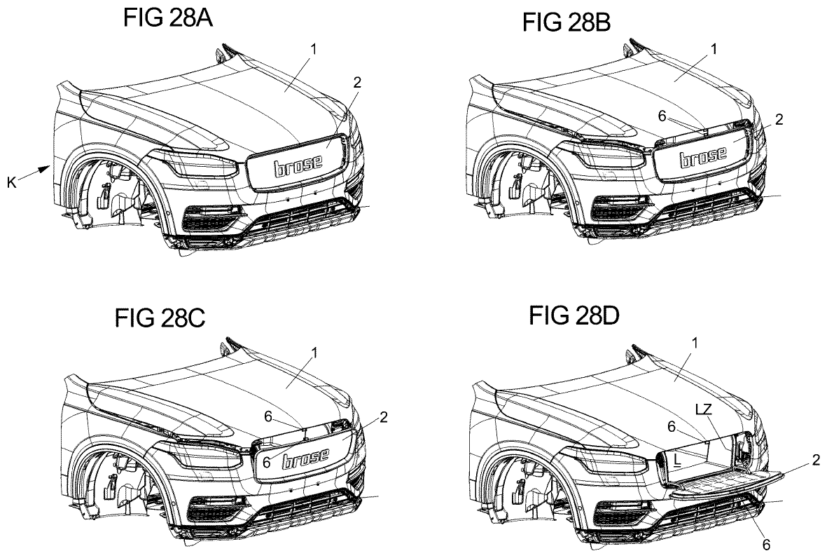

FIGS. 28A to 28D show views of a motor vehicle K with a hood element 1 and an adjustment element 2 in different positions. FIG. 28A shows the hood element 1 and the adjustment element 2, each in a closed position. The hood element 1 closes the loading opening LO and the adjustment element 2 closes the access opening LZ to the cargo space L. FIG. 28B shows the hood element 1 in an intermediate position between the closed position and the open position. The intermediate position is closer to the closed position than to the open position. If the adjustment element 2 is locked via a locking device 6 with which the hood element 1 is locked, the adjustment element 2 can be unlocked in this way. FIG. 28C shows the adjustment element 2 in an intermediate position between the closed and the open position. The adjustment element 2 only moves into the intermediate position if the hood element 1 has been lifted in order to unlock the locking device 6. FIG. 28D shows the adjustment element 2 in the open position. The adjustment element 2 is arranged here in the same plane as the cargo space floor LB. It is used to store objects that can be brought into the cargo space L from there. The hood element 1 is closed again here. To close the adjustment element 2, the hood element 1 can also be adjusted to the intermediate position to allow locking with the locking device 6 before the adjustment element 2 is adjusted to the closed position in which it closes the access opening LZ. The hood element 1 can then be adjusted to the closed position to allow locking to the locking device 6.

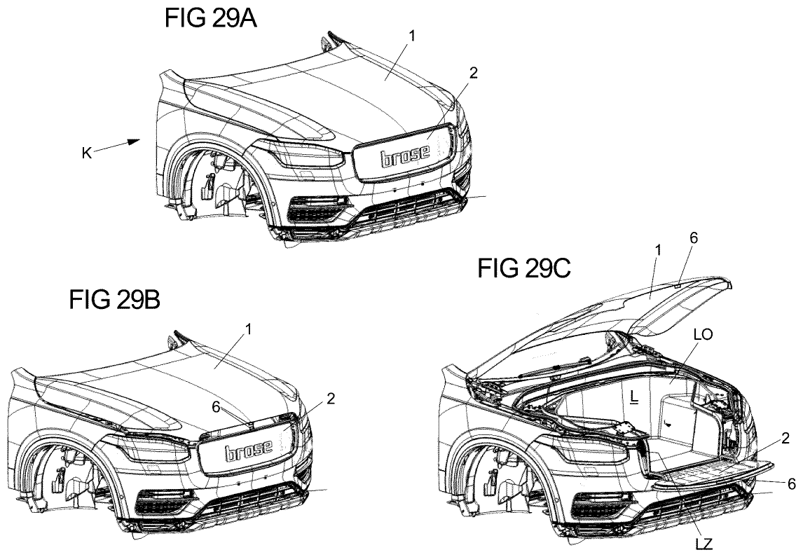

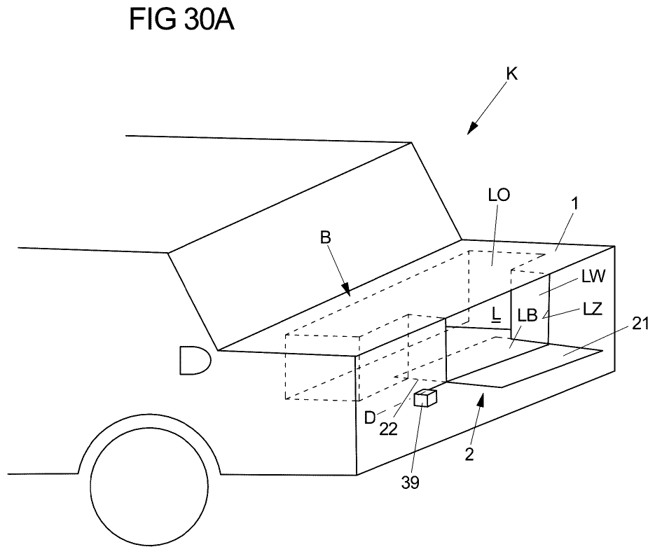

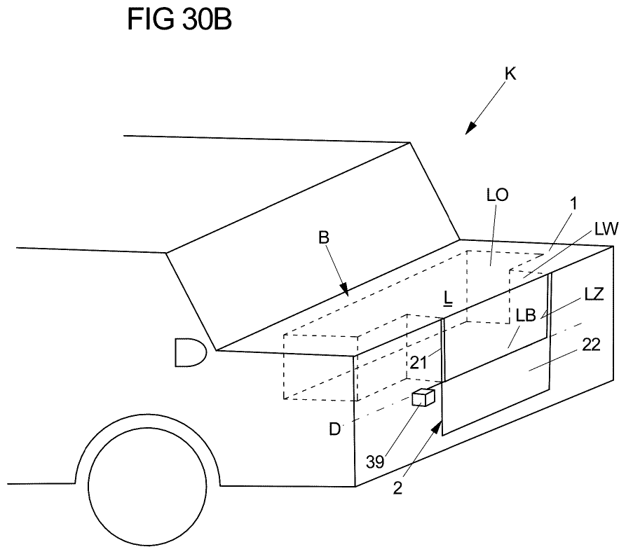

FIG. 29A to FIG. 29C show views of a motor vehicle K with a hood element 1 and an adjustment element 2 in different positions. In FIG. 29A, the hood element 1 and the adjustment element 2 are each in the closed position. To open the loading opening LO and the access opening LZ, the hood element 1 is first adjusted to at least an intermediate position which is different from the closed position. This allows the adjustment element 2 to be unlocked. (see FIG. 29B). The hood element 1 and the adjustment element 2 can then each be adjusted to the open position (see FIG. 29C).

FIGS. 30A and 30B show perspective views of a motor vehicle K comprising a modular assembly B with an adjustment element 2 which is pivotally mounted about an axis of rotation D which divides the adjustment element 2 into a first and a second section 21, 22. The first section 21 serves to close the access opening LZ. The second section 22 is arranged in a direction transverse to the axis of rotation D in the closed position of the adjustment element 2 next to the access opening LZ. Specifically, the second section 22 is arranged below the access opening LZ (see FIG. 30B).

The axis of rotation D divides the adjustment element 2 within a middle third of the adjustment element 2 along its length transversely to the axis of rotation D. By way of example, the axis of rotation D is provided here in the middle of the adjustment element 2. To adjust the adjustment element 2, an adjustment drive 39 is provided, which provides a rotational adjusting force. The adjusting force can be provided via an adjustment gear. This allows a stable and robust adjustment of the adjustment element 2.

### REFERENCE NUMBERS

1 hood element
2 adjustment element
21, 22 sections of the adjustment element
23 floor element
231 loading section
232 step section
233 engagement recess
24 carrier element
25 trim element
250 end section
26 holding device
261 recesses
3 adjustment device
31a, 31b, 31c, 31d adjustment arm
310a, 310b central section
311a, 311b, 312a, 312b mounting point
311c, 312c mounting base
313a, 313b engagement section
314a, 314b actuating section
32 guide assembly
33 pivot element
331 mounting section
332 connecting arm
3321 connecting section
333 support arm
34 sliding guide
34a, 34b sections of the sliding guide
35 slider
36 adjustment assembly
361 traction means
362 deflection element
363 traction means entrainment lug
364 traction means guide
365 traction means drive
37 linear drive
371 drive motor
372 telescopic arm
373 gear assembly
38 stop element
39 adjustment drive
4 bridging assembly
41 bridging element
411 loading section
412 step section
42 entrainment device
421, 422 entrainment lug
423 guide element
423a, 423b entrainment lug section
424 coupling element
444 bracket
43 bridge base
5 terminating element
51 head section
6 locking device
A recess
B modular assembly
D axis of rotation
F front section
G earth's gravity line
K motor vehicle
KL air intake system
KF direction of travel
L cargo space
LB cargo space floor
LD sealing element
LK loading sill
LL mounting element
LO loading opening
LR frame element
LS threshold element
LW cargo space wall
LZ access opening
S electronic control unit
T translation axis
V, V1, V2 adjustment path

What is claimed is:

1. A modular assembly for being arranged on a motor vehicle, comprising
a cargo space for storing objects in the motor vehicle
an access opening to the cargo space, through which an object can be introduced into the cargo space for storage on a cargo space floor, and,
an adjustment element with which the access opening can be closed and which, in addition to a hood element, is provided for closing a loading opening of the cargo space and/or, when the assembly is arranged as intended on the motor vehicle, is arranged in a front section of the motor vehicle, wherein the adjustment element has a first section and a second section, wherein the first section is adjustable along a first adjustment path and the second section along a second adjustment path, each being adjustable at least in sections in a plane parallel or oblique to the cargo space floor in order to open or close the access opening, or wherein a dividing plane which divides the adjustment element, into the first and second sections is arranged perpendicular to the loading floor, or
the adjustment element is arranged on the cargo space via at least one first and at least one second adjustment arm, wherein the adjustment element is adjustable between a closed position in which the access opening is closed and an open position in which the access opening is open, by a rotary adjustment movement of the at least one first adjustment arm and a translational adjustment movement of the at least one second adjustment arm, or
the adjustment element is pivotally mounted about an axis of rotation relative to the cargo space, wherein the mounting is eccentric in relation to the axis of rotation and/or at least one adjustment arm is provided on the adjustment element, which arm can be actuated via a linear drive for pivoting the adjustment element, or
the adjustment element is adjustable via an adjustment device having at least two adjustment arms which are coupled to one another, or
the adjustment element is adjustable via an adjustment device having at least one sliding guide, or,
the adjustment element is pivotally mounted relative to the cargo space about an axis of rotation which divides the adjustment element into a first and a second section.

2. The modular assembly according to claim 1, comprising an adjustment device comprising at least two adjustment arms, wherein the first section of the adjustment element is arranged on at least one first adjustment arm and the second section of the adjustment element is arranged on at least one second adjustment arm.

3. The modular assembly according to claim 2, wherein the at least two adjustment arms are rotatably mounted relative to the cargo space and/or in that the relevant section of the adjustment element is rotatably mounted on the relevant adjustment arm.

4. The modular assembly according to claim 1, wherein the at least one first adjustment arm is pivotable about an axis of rotation which is transverse to a translation axis along which the at least one second adjustment arm is adjustable.

5. The modular assembly according to claim 4, wherein the at least one first and the at least one second adjustment arm are arranged on different sides of the cargo space floor.

6. The modular assembly according to claim 1, wherein the adjustment element in a closed position of the adjustment element has a floor element with which the access opening is closed and which, in an open position in which the access opening is open, is provided for extending the cargo space floor.

7. The modular assembly (B) according to claim 6, comprising a pivot element which is pivotally mounted on the axis of rotation, and on which the adjustment element is arranged on a connecting section of the pivot element, which is spaced at a distance from the axis of rotation (D).

8. The modular assembly according to claim 6, wherein the pivot element has a support arm via which the floor element can be supported at least in the open position of the adjustment element, and/or
the floor element in the closed position is longer than the access opening along an axis perpendicular to the cargo space floor and/or
the floor element can be stowed below the cargo space floor in the closed position of the adjustment element, parallel or at an angle to the cargo space floor and/or
the floor element in the open position for extending the cargo space floor docks directly to the cargo space and/or docks to the cargo space via a bridging assembly.

9. The modular assembly according to claim 1, comprising a floor element which, in a closed position of the adjustment element in which the access opening is closed, is arranged in a stowed position under the cargo space floor and which, in an open position in which the access opening is open, is provided for extending the cargo space floor.

10. The modular assembly according to claim 1, wherein the adjustment device has a first adjustment arm, via which the adjustment element is kinematically coupled to the cargo space, and a second adjustment arm, which is pivotally coupled to the first adjustment arm and which is positively guided along a straight line, so that an adjustment of the second adjustment arm causes a translation of the adjustment element.

11. The modular assembly according to claim 1, wherein the at least two adjustment arms are angled.

12. The modular assembly according to claim 1, wherein the sliding guide is designed such that the adjustment element is arranged below a plane defined by the cargo space floor in an open position in which the adjustment element opens the access opening.

13. The modular assembly (B) according to claim 1, wherein the at least one sliding guide has a first section along which the adjustment element can be guided along a first direction, and a second section along which the adjustment element can be guided along a second direction, the second direction being arranged obliquely to the first direction.

14. The modular assembly according to claim 1, comprising at least two sliding guides on which the adjustment element is adjustably mounted via a single slider, or two sliders via which the adjustment element is adjustably mounted on the at least one sliding guide.

15. The modular assembly according to claim 1, wherein the at least one sliding guide is formed integrally with a cargo space wall which projects upward from the cargo space floor.

16. The modular assembly according to claim 1, wherein the adjustment device has an adjustment assembly with a flexible traction means which can be driven by a traction means drive for adjusting the adjustment element.

17. The modular assembly according to claim 1, wherein the at least one adjustment arm has an engagement section, via which the at least one adjustment arm engages the adjustment element, and an actuating section, via which the at least one adjustment arm can be actuated by the linear drive, wherein the engagement section and the actuating section are spaced apart from one another at an angle of more than 45° with respect to the axis of rotation.

18. The modular assembly according to claim 1, wherein a translation axis, along which the linear drive is adjustable for adjusting the at least one adjustment arm, forms an angle of less than 45° with a perpendicular to the cargo space floor.

19. The modular assembly according to claim 1, wherein the first section of the two sections into which the axis of rotation divides the adjustment element is provided for closing the access opening and the second section is arranged next to the access opening in a direction transverse to the axis of rotation in the closed position of the adjustment element, in which it closes the access opening.

20. A motor vehicle comprising a modular assembly according to claim 1.
